(19) United States
(12) Patent Application Publication
(10) Pub. No.: US 2014/0152668 A1
(43) Pub. Date: Jun. 5, 2014

(54) INFORMATION PROCESSING APPARATUS AND METHOD AND NON-TRANSITORY COMPUTER READABLE MEDIUM

(71) Applicant: FUJI XEROX CO., LTD., Tokyo (JP)

(72) Inventors: Tomoyuki ITO, Kanagawa (JP); Michiaki YASUNO, Kanagawa (JP); Satoru INAKAGE, Kanagawa (JP); Hiroshi UMEMOTO, Kanagawa (JP)

(73) Assignee: FUJI XEROX CO., LTD., Tokyo (JP)

(21) Appl. No.: 13/898,918

(22) Filed: May 21, 2013

(30) Foreign Application Priority Data
Dec. 5, 2012 (JP) 2012-266808

(51) Int. Cl. G06T 11/20

(52) U.S. Cl. CPC G06T 11/206
USPC 345/440

(57) ABSTRACT

An information processing apparatus includes the following elements. A first receiver receives a first QFD chart having axes, items formed in a hierarchical structure being appended to each axis. A second receiver receives a second QFD chart different from the first QFD chart. An integrating unit integrates the first and second QFD charts into a third QFD chart. Concerning axes of the first and second QFD charts having the same axis name, if part of an item name in a highest hierarchical level of items on the axis of the first QFD chart coincides with that of the second QFD chart and if remaining parts do not coincide with each other, the integrating unit sets the consistent parts as an item name in a highest level of the third QFD chart and sets the inconsistent parts as item names in a second highest level of the third QFD chart.

### CROSS-REFERENCE TO RELATED APPLICATIONS

This application is based on and claims priority under 35 USC 119 from Japanese Patent Application No. 2012-266808 filed Dec. 5, 2012.

### BACKGROUND

### Technical Field

The present invention relates to an information processing apparatus and method, and a non-transitory computer readable medium.

### SUMMARY

According to an aspect of the invention, there is provided an information processing apparatus including the following elements. A first receiver receives a first quality function deployment chart (QFD) having at least three axes, items which are formed in a hierarchical structure being appended to each of the axes, an axis name being appended to each of the axes, and an item name being appended to each of the items. A second receiver receives a second QFD, which is different from the first QFD. An integrating unit integrates the first QFD and the second QFD into a third QFD. Concerning an axis of the first QFD and an axis of the second QFD having the same axis name, if part of an item name positioned in a highest hierarchical level of items associated with the axis of the first QFD coincides with part of an item name positioned in a highest hierarchical level of items associated with the axis of the second QFD and if a remaining part of the item name of the first QFD does not coincide with a remaining part of the item name of the second QFD, the integrating unit sets the consistent parts to be an item name in a highest hierarchical level of items on an associated axis of the third QFD and sets the inconsistent parts to be item names in a second highest hierarchical level of items on the associated axis of the third QFD.

### BRIEF DESCRIPTION OF THE DRAWINGS

Exemplary embodiments of the present invention will be described in detail based on the following figures, wherein:

FIG. 1 is a block diagram illustrating conceptual modules forming an information processing apparatus according to a first exemplary embodiment;

FIG. 2 illustrates a system configuration for implementing the first exemplary embodiment;

FIG. 3 is a flowchart illustrating an example of processing according to the first exemplary embodiment;

FIG. 4 is a flowchart illustrating an example of processing according to the first exemplary embodiment;

FIG. 5 illustrates an example of a Quality Function Deployment (QFD) chart A to be processed according to the first exemplary embodiment;

FIG. 6 illustrates an example of a QFD chart B to be processed according to the first exemplary embodiment;

FIG. 7 illustrates an example of a processing result (integrated QFD chart) according to the first exemplary embodiment;

FIGS. 8A, 8B, and 8C illustrate an example of processing according to the first exemplary embodiment;

FIG. 9 is a block diagram illustrating conceptual modules forming an information processing apparatus according to a second exemplary embodiment;

FIG. 10 is a flowchart illustrating an example of processing according to the second exemplary embodiment;

FIG. 11 illustrates an example of the data structure of an axis item table;

FIG. 12 illustrates an example of processing for displaying and selecting axis names;

FIG. 13 illustrates an example of processing for displaying and selecting axis items;

FIG. 14 illustrates a display example of a selected axis name and selected items;

FIG. 15 illustrates a display example of a parts/members QFD chart;

FIG. 16 illustrates a display example of a system QFD chart;

FIG. 17 is a flowchart illustrating another example of processing according to the second exemplary embodiment; and

FIG. 18 illustrates an example of the hardware configuration of a computer implementing an exemplary embodiment of the present invention.

### DETAILED DESCRIPTION

Prior to a description of exemplary embodiments of the present invention, a technology which serves as a base of the exemplary embodiments will first be discussed. This discussion will be given for the purpose of easy understanding of the exemplary embodiments.

As the structure of a technology or a product becomes complicated, the number of cause-and-effect relationships between factors forming the technology or the product becomes increasing, and also, the cause-and-effect relationships are interacted with each other. It is thus difficult to understand the associations between factors. This may bring about the following problems.

(1) it takes time to find cause-and-effect relationships between factors of a technology or a product, thereby decreasing the efficiency in designing and developing the technology or the product.

(2) It is more likely to overlook a problem, and when a problem is found, a designing or developing process has to be suspended and reexamined.

(3) If manufacturing of a product continues without realizing the existence of a problem, quality problems occur.

(4) If an unexpected problem occurs, it takes time to construct a technology for analyzing a phenomenon of the problem, which causes a delay in addressing the problem.

One of the measures to be taken against the above-described problems which may effectively function is a method of analyzing and visualizing factors based on Quality Function Deployment (QFD).

QFD is a method for clarifying targets, problems, and actions to be taken so that customer/client requirements in terms of the quality can be reflected in product manufacturing in various stages, such as product planning, product developing, etc.

A typical form of QFD is a matrix indicating relationships between items of “quality requirements” extracted from items of customer/client requirements and items of “quality characteristics” extracted from factors to be considered in terms of a technology. QFD may also represent relationships between items of “quality requirements” or items of “quality characteristics” in the form of a triangle attic. By applying weights to items of “quality requirements”, items of “planning requirements” (indicating which characteristics will satisfy customers/clients) may be extracted. Also, by associating items of “quality characteristics” with product design values, items of “design requirements” (product specifications) can be extracted. As a result of examining the above-described relationships, relationships among targets, problems, and actions to be taken can be clarified. That is, a QFD chart is a chart in which plural item lists are deployed on axes orthogonal to each other and cause-and-effect relationships between items on adjacent axes are represented in the form of a matrix.

In order to improve QFD, the following proposal has been made. Not only the use of items of “quality requirements” and “quality characteristics”, but also various deployments, such as “parts deployment”, “technology deployment”, and “task deployment”, are performed according to the circumstances, and then, obtained cause-and-effect relationships between items are represented by two-dimensional tables. Moreover, a computer program for displaying these tables is produced, and the items and matrix cells are linked to information on a network, thereby utilizing QFD as a frame for storing and sharing information.

However, some products, such as printers and medical instruments, function in a complicated manner such that many parts/members and plural physical phenomena are interrelated with each other. In the development of such a product, there are a huge number of items to be handled, and also, it is difficult to sufficiently describe relationships between design characteristics and quality requirements by using a simple frame, such as a combination of “quality requirements” and “quality characteristics” or a combination of “parts deployment” and “technology deployment”. Moreover, a process for manufacturing a product is established in coordination of many departments, such as technology development, parts/members development, system development, and manufacturing departments. Accordingly, two-dimensional tables may be created, and symbols representing that “these items may be related” and “these items may not be related” may be assigned. However, unless the entire relationships between design characteristics and quality requirements including a mechanism of a phenomenon “why these items may be related” or “why these items may not be related” can be understood at a glance, it is difficult to utilize QFD in an actual designing and developing process. That is, the manufacturing steps for parts and members and the quality of a manufactured product are indirectly related to each other with various intermediate characteristics therebetween. Unless tables having appropriate intermediate characteristics and configurations are provided, it is difficult to clarify relationships between the manufacturing steps and the quality. The product design conditions and the product quality are also indirectly related to each other with various intermediate characteristics therebetween. Unless tables having appropriate intermediate characteristics and configurations are provided, it is difficult to clarify the relationships between the design conditions and the quality.

Additionally, in many cases, the definition of intermediate characteristics is ambiguous, which makes it difficult to standardize QFD charts. As a result, the use of QFD charts in an actual designing and developing process has not been promoted.

The above-described problems may be addressed by preparing a system which implements the following operations. A cause-and-effect relationship table having axes indicating appropriately defined intermediate characteristics is created. Then, such cause-and-effect relationships are displayed such that the entire relationships between intermediate characteristics can be observed at a glance. The input of items, which are likely to be numerous, positioned on an axis and formation and display of matrices can also be easily performed. However, such a table has three or more axes, and, in particular, when there are a large number of items, a table becomes complicated and large, which may impair the formation of a table. In order to address such a problem, a table may be divided and created by several people, and then, divided tables may be integrated later, thereby significantly reducing the operation load. In this case, the appropriate integration of axes of divided tables is a major factor.

Exemplary embodiments of the present invention will be described below with reference to the accompanying drawings.

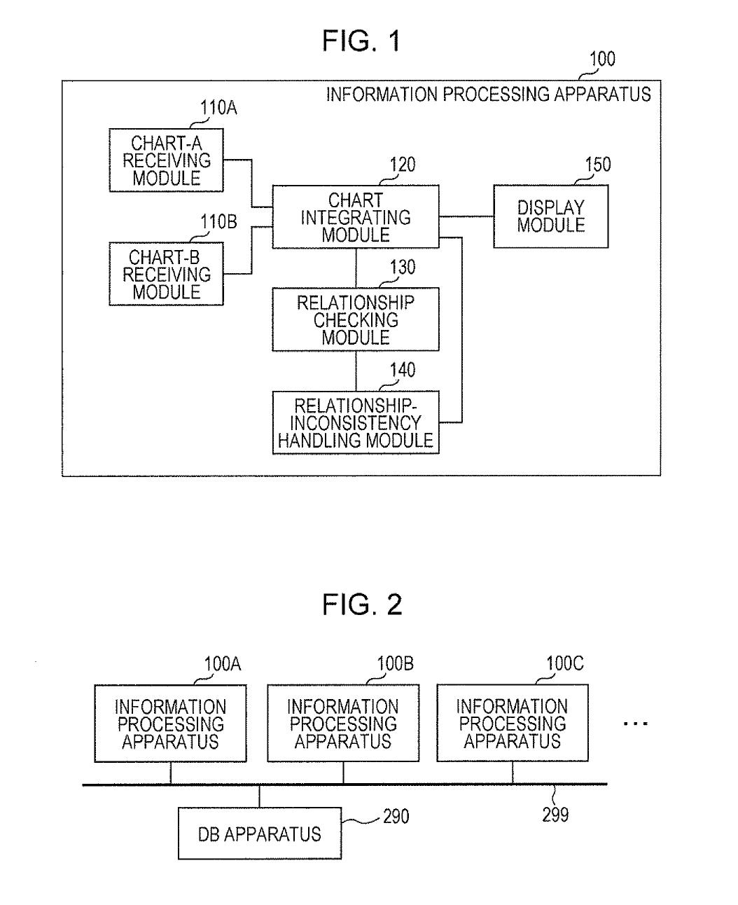

FIG. 1 is a block diagram illustrating conceptual modules forming an information processing apparatus 100 according to a first exemplary embodiment.

Generally, modules are software (computer programs) components or hardware components that can be logically separated from one another. Accordingly, the modules of exemplary embodiments of the invention are not only modules of a computer program, but also modules of a hardware configuration. Thus, the exemplary embodiments will also be described in the form of a computer program for allowing a computer to function as those modules (a program for causing a computer to execute program steps, a program for allowing a computer to function as corresponding units, a computer program for allowing a computer to implement corresponding functions), a system, and a method. While expressions such as “store”, “storing”, “being stored”, and equivalents thereof are used for the sake of description, such expressions indicate, when the exemplary embodiments relate to a computer program, storing the computer program in a storage device or performing control so that the computer program is stored in a storage device. Modules may correspond to functions based on a one-on-one relationship. In terms of implementation, however, one module may be constituted by one program, or plural modules may be constituted by one program. Conversely, one module may be constituted by plural programs. Additionally, plural modules may be executed by using a single computer, or one module may be executed by using plural computers in a distributed or parallel environment. One module may integrate another module therein. Hereinafter, the term “connection” includes not only physical connection, but also logical connection (sending and receiving of data, giving instructions, reference relationship among data elements, etc.). The term “predetermined” means being determined prior to a certain operation, and includes the meaning of being determined prior to a certain operation before starting processing of the exemplary embodiments, and also includes the meaning of being determined prior to a certain operation even after starting processing of the exemplary embodiments, in accordance with the current situation/state or in accordance with the previous situation/state. If there are plural “predetermined values”, they may be different values, or two or more of the values (or all the values) may be the same. A description having the meaning “in the case of A, B is performed” is used as the meaning “it is determined whether case A is satisfied, and B is performed if it is determined that case A is satisfied”, unless such a determination is necessary.

A system or an apparatus may be realized by connecting plural computers, hardware units, devices, etc., to one another via a communication medium, such as a network (including communication based on a one-on-one correspondence), or may be realized by a single computer, hardware unit, device, etc. The terms “apparatus” and “system” are used synonymously. The term “system” does not include merely a man-made social “mechanism” (social system).

Additionally, every time an operation is performed by using a corresponding module or every time each of plural operations is performed by using a corresponding module, target information is read from a storage device, and after performing the operation, a processed result is written into the storage device. Accordingly, a description of reading from the storage device before an operation or writing into the storage device after an operation may be omitted. Examples of the storage device may be a hard disk, a random access memory (RAM), an external storage medium, a storage device using a communication line, a register within a central processing unit (CPU), etc.

The information processing apparatus 100 of the first exemplary embodiment includes, as shown in FIG. 1, a chart-A receiving module 110A, a chart-B receiving module 110B, a chart integrating module 120, a relationship checking module 130, a relationship-inconsistency handling module 140, and a display module 150.

The information processing apparatus 100 is utilized for supporting design and development in order to improve the efficiency in developing technologies and products and also to enhance the qualities of technologies and products. More specifically, the information processing apparatus 100 is utilized for creating a QFD chart by integrating plural QFD charts formed by several operators in cooperation with each other or by one operator.

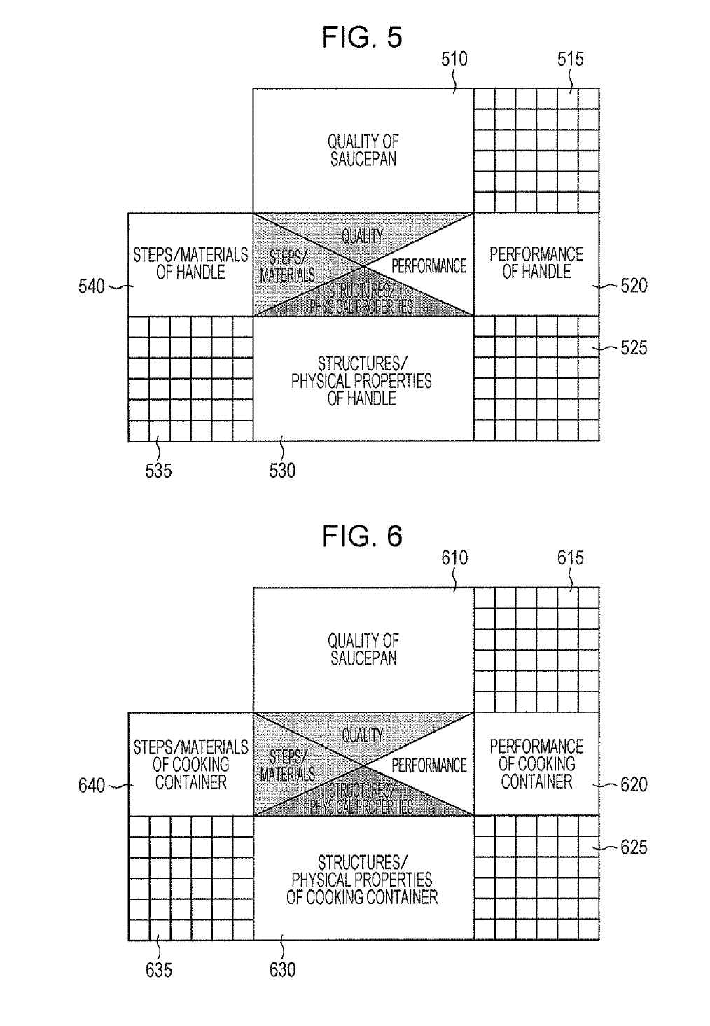

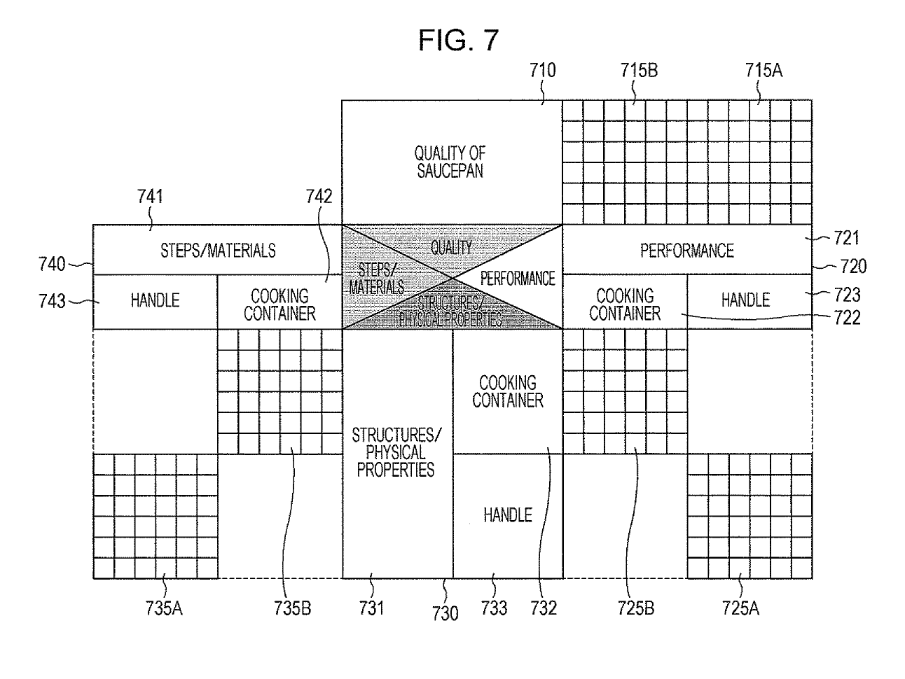

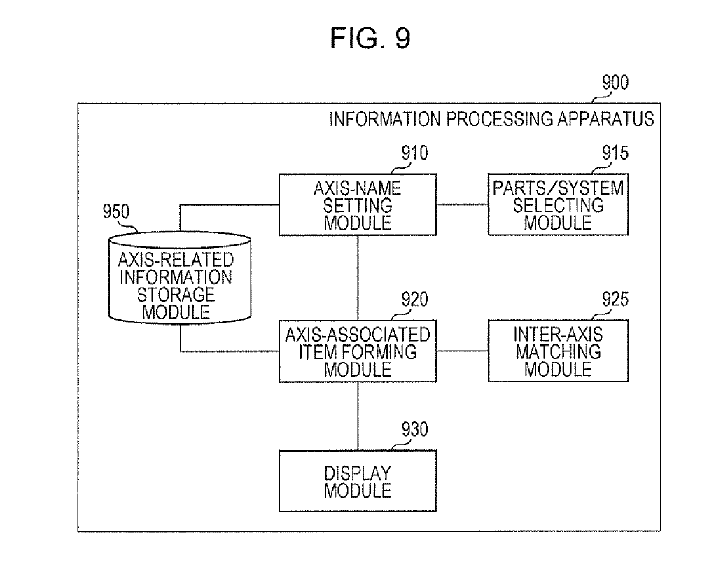

The chart-A receiving module 110A is connected to the chart integrating module 120. The chart-A receiving module 110A receives a QFD chart A. A QFD chart includes at least three axes. Items formed in a hierarchical structure are appended to each of the axes. An axis name is appended to each axis, and an item name is appended to each item. A matrix into which cause-and-effect relationships between items may be input may be deployed between two adjacent axes. Specific examples of QFD charts will be discussed later with reference to FIGS. 9 through 17. The QFD chart A, for example, a QFD chart A shown in FIG. 5, is a subject to be integrated. Although it is not shown, items in a small classification level are appended to each of axes of QFD charts shown in FIGS. 5, 6, and 7. More specifically, items in two levels, such as large and small classification levels, are appended to, for example, a first axis 510, of the QFD chart A shown in FIG. 5. Items in three levels, such as large, medium, and small classification levels, are appended to, for example, a second axis 720, of a QFD chart shown in FIG. 7.

The chart-B receiving module 110B is connected to the chart integrating module 120. The chart-B receiving module 110B receives a QFD chart B. The QFD chart B is different from the QFD chart A, otherwise there is no point in integrating the QFD charts A and B. The QFD chart B is, for example, a QFD chart B shown in FIG. 6.

The chart integrating module 120 is connected to the chart-A receiving module 110A, the chart-B receiving module 110B, the relationship checking module 130, the relationship-inconsistency handling module 140, and the display module 150. The chart integrating module 120 integrates a QFD chart A and a QFD chart B into a single QFD chart C. This will be described more specifically. It is now assumed that, concerning an axis of the QFD chart A and an associated axis of the QFD chart B having the same axis name, part of an item name positioned in the highest hierarchical level of items associated with the axis of the QFD chart A coincides with that of the QFD chart B and the remaining part of the item name of the QFD chart A does not coincide with that of the QFD chart B. In this case, when integrating the QFD chart A and the QFD chart B into a new QFD chart C, the chart integrating module 120 sets the consistent part of the item name to be an item name in the highest hierarchical level of items on an associated axis of the QFD chart C and sets the inconsistent parts of the item name to be item names in the second highest hierarchical level of items on the associated axis of the QFD chart C.

In the above-described example, “an axis of the QFD chart A and an associated axis of the QFD chart B having the same axis name” means that the two axes are located at the same position of the QFD charts A and B. If the two associated axes do not have the same axis name, a message indicating that such QFD charts are not subjects to be integrated may be displayed on a display device, such as a display. For example, if the name of an axis of the QFD chart A is “performance”, an associated axis having the name “performance” of the QFD chart B is a subject to be integrated. In the QFD charts A and B shown in FIGS. 5 and 6, respectively, a second axis 520 and a second axis 620 are subjects to be integrated.

In the above-described example, a case in which “part of an item name positioned in the highest hierarchical level of items associated with the axis of the QFD chart A coincides with that of the QFD chart B and the remaining part of the item name of the QFD chart A does not coincide with that of the QFD chart B” will be discussed more specifically. Items associated with an axis of the QFD chart A and those of the QFD chart B having the same axis name are subjects to be integrated. The items are formed in a hierarchical structure having, for example, large, medium, and small classification levels. Even if there is only one level (for example, a large classification level), an item classified under this level may be considered to form a hierarchical structure. An item name is appended to each hierarchical level. It is then determined whether part of an item name appended to the highest hierarchical level (the large classification level in the above-described example) of the QFD chart A coincides with part of the item name of the QFD chart B and whether the remaining part of the item name of the QFD chart A does not coincide with that of the QFD chart B. For example, the item name of the highest hierarchical level appended to the second axis 520 shown in FIG. 5 and that of a second axis 620 shown in FIG. 6 are respectively “performance of handle” and “performance of cooking container”. In this case, part (word) of the item name “performance” of the QFD chart A and that of the QFD chart B coincide with each other, and the remaining parts “handle” and “cooking container” do not coincide with each other. Accordingly, the item name of the QFD chart A and the item name of the QFD chart B are subjects to be integrated. A determination as to whether an item name of the QFD chart A and that of the QFD chart B partially coincide with each other (hereinafter may be referred to as “partial matching”) may be made by conducting morphological analysis on the item name. More specifically, the item name is divided into plural words and the above-described determination may be made by comparing the divided words. Alternatively, the item name may be divided into groups of consecutive character strings according to character types (Hiragana (Japanese character type), Katakana (Japanese character type), Kanji (Chinese character type), alphabetic characters, numeric characters, etc.), and the above-described determination may be made by comparing the divided groups of character strings. In this case, it is possible that Japanese particles (as in English prepositions), for example, “No” in Japanese, which means “of” in English, be not subjects to be compared.

A description “setting the consistent part of the item name to be an item name in the highest hierarchical level and setting the inconsistent parts of the item name to be item names in the second highest hierarchical level” will be discussed more specifically. In the above-described example, the consistent part is “performance”, and “performance” is set to be an item name in the highest hierarchical level of an associated axis of the QFD chart C. Then, “handle” and “cooking container” are set to be item names in the second highest hierarchical level of the axis of the QFD chart C. That is, as in the QFD chart C shown in FIG. 7, items within a second axis 720 are divided into a large classification item 721 (“performance”), a medium classification item 722 (“cooking container”), and a medium classification item 723 (“handle”).

Concerning an axis of the QFD chart A and an associated axis of the QFD chart B having the same axis name, if item names of items associated with the axis of the QFD chart A and the hierarchical structure of the items coincide with those of the QFD chart B, the chart integrating module 120 integrates two associated items into a single item in the QFD chart C. This integration processing is performed when items associated with two axes perfectly match each other (perfect matching). “Perfect matching” means that the number of hierarchical levels, the number of items in each hierarchical level, and the item names in each hierarchical level of the QFD chart A perfectly match those of the QFD chart B. “Two associated items” are an item of the QFD chart A and an item of the QFD chart B which are subjected to be compared with each other to determine whether they coincide with each other. For example, the first axis 510 shown in FIG. 5 and the first axis 610 shown in FIG. 6 are an example of two associated items which coincide with each other, and they are integrated into a first axis 710 shown in FIG. 7.

If, concerning an axis of the QFD chart A and an associated axis of the QFD chart B having the same axis name, the name of an item positioned in the highest hierarchical level of items associated with the axis of the QFD chart A coincides with that of the QFD chart B and the names of the items positioned in levels other than the highest hierarchical level do not coincide with each other, the chart integrating module 120 disposes two inconsistent items (having different item names) in parallel in an associated level of the QFD chart C. For example, if both item names in the large classification level are “performance”, and item names in the medium classification level do not coincide with each other, the item names are disposed, such as those in a second axis 720 shown in FIG. 7. This result is the same result of integrating the second axis 520 shown in FIG. 5 and the second axis 620 shown in FIG. 6.

If, concerning an axis of the QFD chart A and an associated axis of the QFD chart B having the same axis name, the chart integrating module 120 has determined that the name of an item positioned in the highest hierarchical level of items associated with the axis of the QFD chart A is different from that of the QFD chart B, it displays, on a display device, such as a display, a message indicating that it is not possible to integrate the QFD chart A and the QFD chart B. In this case, “the names of items in the highest hierarchical level are different” means that the names of the items do not even partially coincide with each other.

If an item on each of two adjacent axes of one QFD chart (QFD chart A) and an item of the associated axis of another QFD chart (QFD chart B) have been integrated, the chart integrating module 120 causes the relationship checking module 130 and the relationship-inconsistency handling module 140 to perform corresponding processing. A case in which “an item on each of two adjacent axes of one QFD chart and that of another QFD chart have been integrated” means that an item on each of two adjacent axes of one QFD chart perfectly matches an item of the associated axis of another QFD chart. That is, an item within an axis of the QFD chart A (or that of the QFD chart B) can be copied as an item of an associated axis of the QFD chart C. The above-described case does not apply to a case in which an item of only one axis of one QFD chart and that of another QFD chart have been integrated and if items of the other axes of the QFD charts are disposed in parallel.

The relationship checking module 130 is connected to the chart integrating module 120 and the relationship-inconsistency handling module 140. The relationship checking module 130 checks whether or not values, which represent relationships between items, input in elements (cells) forming a matrix between two adjacent axes of one QFD chart are different from those of another QFD chart. For example, if values input in elements within a first-axis/second-axis correlation matrix 515 of the QFD chart A shown in FIG. 5 are different from those within a first-axis/second-axis correlation matrix 615 of the QFD chart B shown in FIG. 6, the relationship checking module 130 causes the relationship-inconsistency handling module 140 to perform processing. If the values within the first-axis/second-axis correlation matrix 515 are not different from those within the first-axis/second-axis correlation matrix 615, the relationship checking module 130 supplies information indicating that there is no inconsistency between the values within the two matrices to the chart integrating module 120. Then, the chart integrating module 120 sets the matrix (including the values representing relationships between items) of the QFD chart A (or the QFD chart B) to be a matrix of the QFD chart C. That is, in the QFD chart A, the QFD chart B, and the QFD chart C, two corresponding axes (including items) are identical, and the matrix between these axes is also identical. In this case, cells of the QFD chart A to be compared with cells of the QFD chart B are cells located at the same position of the matrices. The position of a cell is specified by corresponding items of the two axes.

The relationship-inconsistency handling module 140 is connected to the chart integrating module 120 and the relationship checking module 130. If it is determined by the relationship checking module 130 that values input in cells forming a matrix between two adjacent axes of one QFD chart are different from those of another QFD chart, the relationship-inconsistency handling module 140 selects one of the following two error handling types. In one error handling type, information indicating that integration processing will not be performed since it is not possible to integrate two QFD charts is displayed. In the other error handling type, values input in corresponding cells of one of the QFD charts are set. Which of the error handling types will be selected may be determined in advance, or may be selected through an operation performed by an operator. Then, in accordance with the error handling type selected by the relationship-inconsistency handling module 140, the chart integrating module 120 displays information indicating that integration processing will not be performed since it is not possible to integrate two QFD charts, or sets values in corresponding cells of one of the QFD charts.

The display module 150 is connected to the chart integrating module 120. The display module 150 displays the QFD chart C created by the chart integrating module 120 on a display device, such as a display.

FIG. 2 illustrates a system configuration for implementing the first exemplary embodiment (or a combination of the first exemplary embodiment and a second exemplary embodiment). The system configuration shown in FIG. 2 is a configuration in which items described in a QFD chart are associated with pieces of information stored in a DB 290 apparatus and users are allowed to share these pieces of information.

Information processing apparatuses 100A, 100B, and 1000 and the DB apparatus 290 are connected to one another with a communication line 299. The information processing apparatuses 100A, 100B, and 100C each correspond to the information processing apparatus 100 shown in FIG. 1. The DB apparatus 290 stores, for example, a QFD chart A created by the information processing apparatus 100A through an operation performed by an operator A, and a QFD chart B created by the information processing apparatus 100B through an operation performed by an operator B. Then, the information processing apparatus 100C reads the QFD chart A and the QFD chart B stored in the DB apparatus 290 through an operation performed by an operator C and integrates the QFD chart A and the QFD chart B into a QFD chart C. That is, the QFD chart A and the QFD chart B, which are parts of the QFD chart C, are created through operations performed by the operator A and the operator B, respectively. Then, the QFD chart A and the QFD chart B are integrated into the QFD chart C through an operation performed by the operator C.

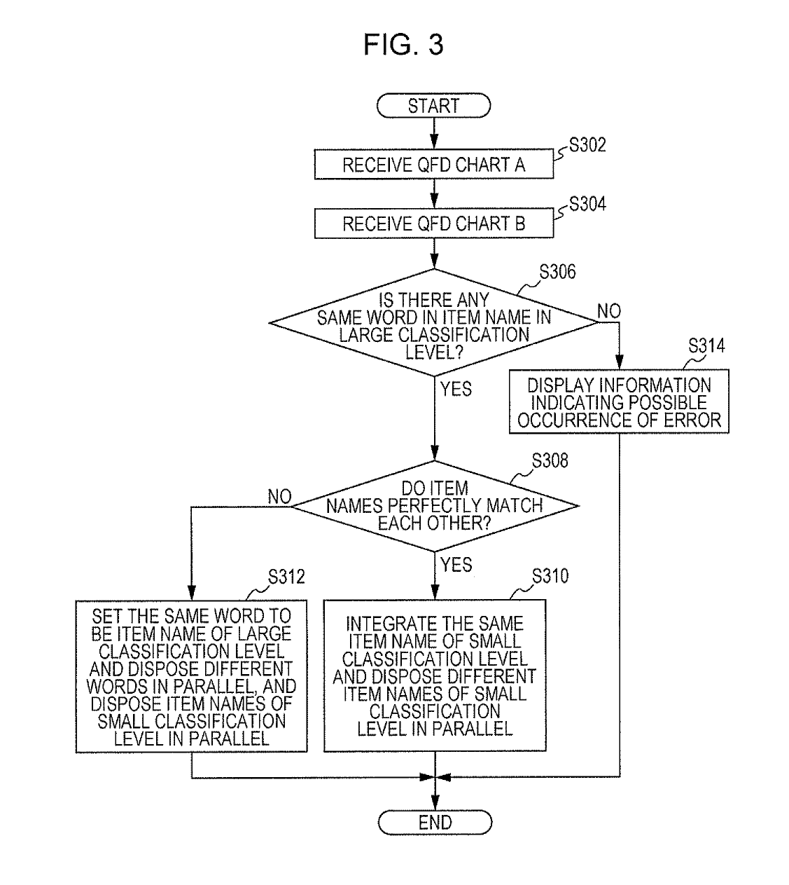

FIG. 3 is a flowchart illustrating an example of processing according to the first exemplary embodiment.

In step S302, the chart-A receiving module 110A receives a QFD chart A. The QFD chart A may be a QFD chart shown in FIG. 5.

In step S304, the chart-B receiving module 110E receives a QFD chart B. The QFD chart B may be a QFD chart shown in FIG. 6.

In step S306, the chart integrating module 120 determines whether the QFD chart A and the QFD chart B contain the same word in an item name in a large classification level of items. If the result of step S306 is YES, the process proceeds to step S308. If the result of step S306 is NO, the process proceeds to step S314. In the QFD charts shown in FIGS. 5 and 6, there is the same word in associated axes of the QFD charts, and thus, the process proceeds to step S308. More specifically, there are the same words in associated axes, such as “saucepan” and “quality”, in the first axis 510 and the first axis 610, “performance” in the second axis 520 and the second axis 620, “structures and physical properties” in a third axis 530 and a third axis 630, and “steps/materials” in a fourth axis 540 and a fourth axis 640.

In step S308, the chart integrating module 120 determines whether the item names in associated axes of the QFD chart A and the QFD chart B perfectly match each other. If the result of step S308 is YES, the process proceeds to step S310. If the result of step S308 is NO, the process proceeds to step S312. Since the item name “quality of saucepan” in the first axis 510 perfectly matches that of the first axis 610, the process proceeds to step S310. On the other hand, there are different words in item names between the second axes 520 and 620, the third axes 530 and 630, and the fourth axes 540 and 640, and thus, the process proceeds to step S312.

In step S310, the chart integrating module 120 integrates items having the same item name of a small classification level and disposes different item names of small classification levels in parallel. If the item names within the axis of the QFD chart A perfectly match those of the QFD chart B, as well as the positions of the items in the hierarchical levels, the chart integrating module 120 integrates these items. “Integrating of items” means that the items within an axis of one of the QFD charts are copied onto an associated axis of a new QFD chart (QFD chart C). If items in hierarchical levels lower than the large classification level of an axis of one QFD chart are different from those of another QFD chart, both items are disposed in parallel in associated axis of a new QFD chart (QFD chart C). “Disposing items in parallel” means that items of associated axes of both QFD charts are copied as items of an associated axis of the QFD chart C. Accordingly, the number of items of the axis of the QFD chart C is equal to the total number of items of the associated axis of the QFD chart A and those of the QFD chart B.

In step S312, the chart integrating module 120 sets the same word in the associated axes of the QFD chart A and the QFD chart B to be an item name in a large classification level of the QFD chart C and disposes different words in parallel in a classification level lower than the large classification level of the QFD chart C. The chart integrating module 120 also disposes items in parallel in a small classification level in the QFD chart C. More specifically, the second axis 720 including the large classification level 721 and the medium classification levels 722 and 723 is generated from the second axes 520 and 620 shown in FIGS. 5 and 6, respectively. A third axis 730 including a large classification level 731 and medium classification levels 732 and 733 is generated from the third axes 530 and 630 shown in FIGS. 5 and 6, respectively. A fourth axis 740 including a large classification level 741 and medium classification levels 742 and 743 is generated from the fourth axes 540 and 640 shown in FIGS. 5 and 6, respectively.

In step S314, the display module 150 displays information indicating the possible occurrence of an error. If it is found in step S306 that the names of the items in a large classification level do not even partially coincide with each other, the display module 150 issues a warning to indicate that the QFD chart A and the QFD chart B are not subjects to be integrated.

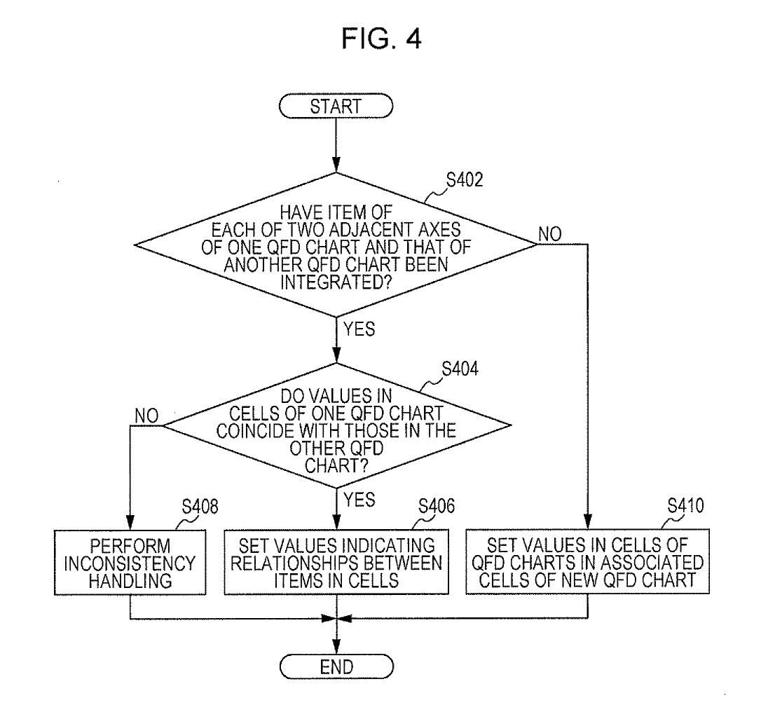

After finishing the processing shown in the flowchart of FIG. 3, the display module 150 may display the QFD chart C on a display device, such as a display. However, at this time, in the QFD chart C, values are not yet input into the cells in a matrix disposed between two axes. In order to set values in the cells of matrices of the QFD chart C by utilizing values input in the cells of matrices of the QFD chart A and those in the QFD chart B, processing indicated in the flowchart of FIG. 4 is performed.

FIG. 4 is a flowchart illustrating an example of processing according to the first exemplary embodiment. The processing indicated in this flowchart is performed after finishing the processing indicated in the flowchart of FIG. 3.

In step S402, the chart integrating module 120 determines whether an item on each of two adjacent axes of one QFD chart (QFD chart A) and that of another QFD chart (QFD chart B) have been integrated. If the result of step S402 is YES, the process proceeds to step S404. If the result of step S402 is NO, the process proceeds to step S410.

In step S404, the relationship checking module 130 determines whether values input in the cells of a matrix disposed between the two adjacent axes of the QFD chart A coincide with those of the QFD chart B. If the result of step S404 is YES, the process proceeds to step S406. If the result of step S404 is NO, the process proceeds to step S408. In this case, “values input in cells of a matrix of the QFD chart A coincides with those of the QFD chart B” indicates that there is no inconsistency between the cells of the QFD chart A and those of the QFD chart B. That is, the determination results of the relationships between the items of the QFD chart A created by the operator A are the same as those of the QFD chart B created by the operator B.

In step S406, the chart integrating module 120 sets values indicating the relationships between items in cells. That is, the chart integrating module 120 sets the values within the cells of the QFD chart A (or the QFD chart B) in the associated cells of the QFD hart C.

In step S408, the chart integrating module 120 performs an inconsistency handling operation selected by the relationship-inconsistency handling module 140. More specifically, as stated above, the chart integrating module 120 displays information indicating that integration processing will not be performed since it is not possible to integrate the two QFD charts, or sets values within corresponding cells of one of the QFD charts in a new QFD chart.

In step S410, the chart integrating module 120 sets the values input in cells of the QFD charts. That is, the chart integrating module 120 sets all the values within a matrix between the two adjacent axes of the QFD chart A in an associated matrix of the QFD chart C and sets all the values within a matrix between the two adjacent axes of the QFD chart B in an associated matrix of the QFD chart C.

Then, the display module 150 displays the QFD chart C on a display device, such as a display. For example, if the QFD chart A shown in FIG. 5 and the QFD chart B shown in FIG. 6 are received, the display module 150 displays the QFD chart C shown in FIG. 7. The medium classification item 722 corresponds to the second axis 620 shown in FIG. 6, the medium classification item 723 corresponds to the second axis 520 shown in FIG. 5, the medium classification item 732 corresponds to the third axis 630 shown in FIG. 6, the medium classification item 733 corresponds to the second axis 530 shown in FIG. 5, the medium classification item 742 corresponds to the fourth axis 640 shown in FIG. 6, and the medium classification item 743 corresponds to the fourth axis 540 shown in FIG. 5. A first-axis/second-axis correlation matrix (handle) 715A corresponds to the first-axis/second-axis correlation matrix 515 shown in FIG. 5, and a first-axis/second-axis correlation matrix (cooking container) 715E corresponds to the first-axis/second-axis correlation matrix 615 shown in FIG. 6. A second-axis/third-axis correlation matrix (handle) 725A corresponds to the second-axis/third-axis correlation matrix 525 shown in FIG. 5, and a second-axis/third-axis correlation matrix (cooking container) 725B corresponds to the second-axis/third-axis correlation matrix 625 shown in FIG. 6. A third-axis/fourth-axis correlation matrix (handle) 735A corresponds to the third-axis/fourth-axis correlation matrix 535 shown in FIG. 5, and a third-axis/fourth-axis correlation matrix (cooking container) 735B corresponds to the third-axis/fourth-axis correlation matrix 635 shown in FIG. 6.

As a modified example of the first exemplary embodiment, the chart integrating module 120 may perform processing in the following manner. It is now assumed that, concerning an axis of the QFD chart A and an associated axis of the QFD chart B having the same axis name, as a result of sequentially extracting items associated with this axis both in the QFD charts A and B starting from the highest hierarchical level of the items, an item name positioned in a certain level of the QFD chart A coincides with that in the same level of the QFD chart B, and item names positioned in levels lower than this certain level of the QFD chart A do not coincide with those of the QFD chart B. In this case, the chart integrating module 120 integrates the QFD chart A and the QFD chart B into the QFD chart C by setting consistent item names to be a common item name in the associated hierarchical level of the QFD chart C and by disposing inconsistent item names in parallel in a corresponding hierarchical level of the QFD chart C. In the above-described case, items are formed in a hierarchical structure, and item names in higher hierarchical levels of one QFD chart coincide with those of another QFD chart, while item names in lower hierarchical levels of the two QFD charts do not coincide with each other. When sequentially checking item names from a higher level to a lower level, if there are item names which do not coincide with each other in a certain level, it is assumed that item names in levels lower than this certain level do not coincide with each other.

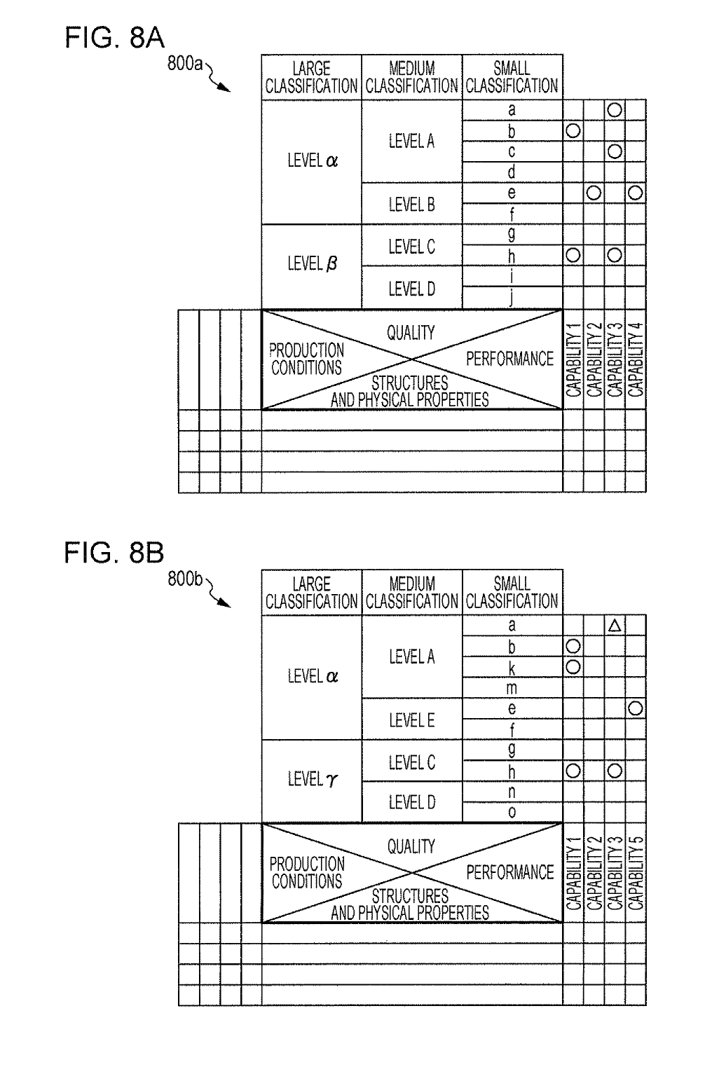

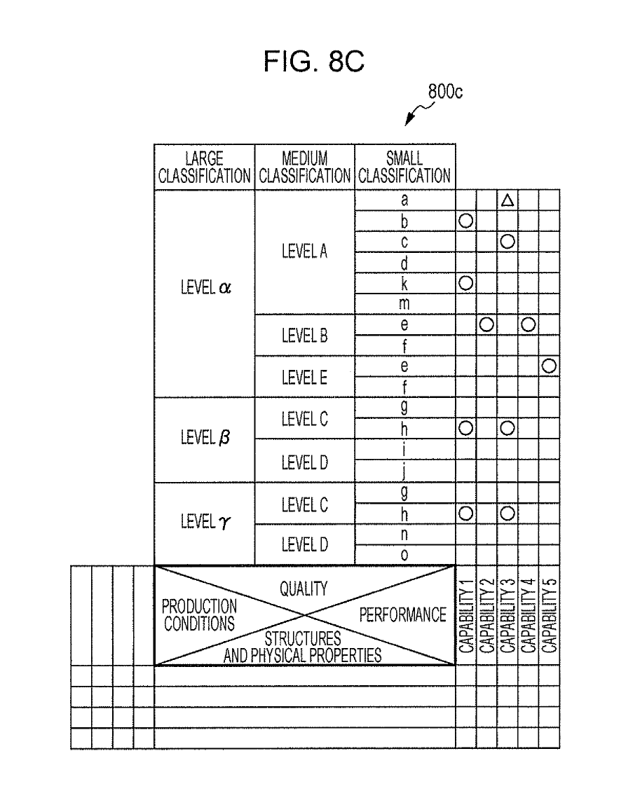

This will be described more specifically with reference to FIGS. 8A through 8C. FIGS. 8A through 8C illustrate an example of processing according to the first exemplary embodiment.

A QFD chart 800c shown in FIG. 8C is created by integrating a QFD chart 800a shown in FIG. 8A and a QFD chart 800b shown in FIG. 8B.

The chart integrating module 120 determines that combining processing can be performed since all axis names of axes of the QFD chart 800a coincide with those of the QFD chart 800b. A “quality” axis, which is a first axis, is formed in a hierarchical structure having three levels (large, medium, and small classification levels).

Small classification items a and b in the QFD chart 800a and the QFD chart 800b are classified under the same large classification level a, the same medium classification level A, and the same small classification level starting from the highest level. Accordingly, the small classification items a and b in the QFD charts 800a and 800b are integrated as common classification items a and b classified under the same three levels. Accordingly, in the integrated QFD chart 800c, the small classification items a and b are singly provided.

Small classification items c and d in the QFD chart 800a and small classification items k and m in the QFD chart 800b are classified under the same large classification level α and the same medium classification level A starting from the highest level. Accordingly, the small classification items c and d and k and m are integrated as common classification items c, d, k, and m classified under the same two higher levels. That is, the small classification items c, d, k, and m are disposed in parallel in the same small classification level of the QFD chart 800c.

Small classification items e and f in the QFD chart 800a and those in the QFD chart 800b are classified under the same large classification level a, but not under the same medium classification level. Accordingly, the small classification items e and f are integrated as common classification items e and f classified only under the same large classification level α. That is, in the QFD chart 800c, the medium classification items B and E are disposed in parallel in the same medium classification level, and the small classification items e and f are disposed in parallel in the same small classification level but under the different medium classification levels.

Small classification items g and h in the QFD chart 800a and those in the QFD chart 800b are not classified under the same large classification level, and thus, they are not integrated. That is, without being integrated, the large classification items β and γ are disposed in parallel in the same large classification level, the medium classification item C is disposed in the medium classification level, and the small classification items g and h are disposed in parallel in the same small classification level.

Small classification items i and j in the QFD chart 800a and small classification items n and o in the QFD chart 800b are classified under the same medium classification level, but not under the same large classification level, and thus, they are not integrated. That is, without being integrated, the large classification items β and γ are disposed in parallel in the same large classification level, the medium classification item D is disposed in the medium classification level, and the small classification items i, j, n, and o are disposed in parallel in the same small classification level.

The “performance” axis has only one level, and the highest level is the first level. Thus, items having the same item name (capability 1, capability 2, and capability 3) are integrated as common items, and items having different item names (capability 4 and capability 5) are disposed in parallel.

If it is determined by the relationship checking module 130 that there is no inconsistency between values within cells of a matrix of the QFD chart 800a and those of the QFD chart 800b, the chart integrating module 120 copies these values onto the associated cells of the QFD chart 800c.

In the cell at the intersection of the small classification item a and the capability 3, ◯ is input in the QFD chart 800a and Δ is input in the QFD chart 800b, and the two values are inconsistent. In this case, the chart integrating module 120 displays a screen to ask a user about which of the values will be used. Alternatively, the chart integrating module 120 may perform an inconsistency handling operation on the basis of the error handling type selected by the relationship-inconsistency handling module 140. More specifically, the chart integrating module 120 may display information indicating that it is not possible to integrate the two QFD charts and may terminate processing. Alternatively, the chart integrating module 120 may specify in advance which of the two QFD charts will be preferentially used.

In the above-described first exemplary embodiment, two QFD charts are integrated by way of example, however, three or more QFD charts may be integrated. In this case, for example, two QFD charts may be integrated first, and then, an integrated QFD chart and a remaining QFD chart may be integrated. This process may be repeated.

FIG. 9 is a block diagram illustrating conceptual modules of an example of the configuration of a second exemplary embodiment. In the second exemplary embodiment, QFD charts to be integrated in the first exemplary embodiment are created and displayed.

An information processing apparatus 900 of the second exemplary embodiment includes, as shown in FIG. 9, an axis-name setting module 910, a parts(members)/system selecting module 915 (hereinafter simply referred to as “parts/system selecting module 915”), an axis-associated item forming module 920, an inter-axis matching module 925, a display module 930, and an axis-related information storage module 950.

The information processing apparatus 900 is utilized for supporting design and development in order to improve the efficiency in developing technologies and products and also to enhance the qualities of technologies and products.

The parts/system selecting module 915 is connected to the axis-name setting module 910. The parts/system selecting module 915 is used for selecting the type of QFD chart to be formed, and more specifically, the parts/system selecting module 915 selects one of (1) a QFD chart for clarifying relationships between the manufacturing steps for parts and members and the quality of a product obtained by assembling these parts or members (hereinafter may also be referred to as a “parts/members QFD chart”) and (2) a QFD chart for clarifying relationships between the design conditions in developing a technology or a product and the quality of the technology or the product (hereinafter may also be referred to as a “system QFD chart”). The names of axes and items associated with the axes, which will be discussed later, will be different depending on which of the parts/members QFD chart and the system QFD chart is selected. In this case, an operator may select the type of QFD chart by performing a selecting operation. Alternatively, the type of QFD chart may be selected according to an operator, or the department or the job type of an operator. For example, a table in which operator identifiers for uniquely identifying operators in this exemplary embodiment are individually associated with the parts/members QFD chart or the system QFD chart may be prepared and stored in the axis-related information storage module 950, and by using this table, the type of QFD chart may be selected from an operator identifier. Alternatively, a table in which operators are individually associated with departments or job types, and a table in which departments or job types are individually associated with the parts/members QFD chart or the system QFD chart may be prepared and stored in the axis-related information storage module 950. By using these two tables, the QFD chart may be selected from an operator identifier for uniquely identifying an associated operator.

The axis-name setting module 910 is connected to the parts/system selecting module 915, the axis-associated item forming module 920, and the axis-related information storage module 950. The axis-name setting module 910 sets names of first through fourth axes. In this case, the concept of setting of the names of axes includes generating of the names of axes. The axis-name setting module 910 may set the names of the first through fourth axes on the basis of a selection result of the parts/system selecting module 915. That is, if the parts/members QFD chart has been selected by the parts/system selecting module 915, the axis-name setting module 910 may set “quality” as the name of the first axis, “performance” as the name of the second axis, “structures and physical properties” as the name of the third axis, and “production conditions” as the name of the fourth axis. If the system QFD chart has been selected by the parts/system selecting module 915, the axis-name setting module 910 may set “quality” as the name of the first axis, “mechanism” as the name of the second axis, “physical characteristics” as the name of the third axis, and “design conditions” as the name of the fourth axis.

The axis-associated item forming module 920 is connected to the axis-name setting module 910, the inter-axis matching module 925, the display module 930, and the axis-related information storage module 950. The axis-associated item forming module 920 forms, through a selecting operation performed by an operator, items associated with axes for which names are set by the axis-name setting module 910. The axis-associated item forming module 920 forms (1) items indicating quality requirements of a product, as items associated with the first axis, (2) items indicating performance capabilities provided by the individual parts and members in order to satisfy the quality requirements of the product, as items associated with the second axis, (3) items concerning the structures and the physical properties of the individual parts and members, as items associated with the third axis, and (4) items which define production conditions for the individual parts and members, as items associated with the fourth axis.

Particularly when the parts/members QFD chart is selected by the parts/system selecting module 915, the axis-associated item forming module 920 may form, through a selecting operation performed by an operator, (1) items indicating quality requirements of a product, as items associated with the first axis, (2) items indicating performance capabilities provided by the individual parts and members in order to satisfy the product quality requirements, as items associated with the second axis, (3) items concerning the structures and the physical properties of the individual parts and members, as items associated with the third axis, and (4) items which define design conditions for the individual parts and members, as items associated with the fourth axis.

Alternatively, particularly when the system QFD chart is selected by the parts/system selecting module 915, the axis-associated item forming module 920 may form, through a selecting operation performed by an operator, (1) items indicating quality requirements of a product, as items associated with the first axis, (2) items concerning a physical mechanism whose behavior is determined by items of physical characteristics and which dominates the quality of the product, as items associated with the second axis, (3) items indicating system physical characteristics determined by design conditions, as items associated with the third axis, and (4) items indicating design conditions, as items associated with the fourth axis. Additionally, as items associated with each of the first through fourth axes, in addition to the individual parts and members, “all parts/members” (large classification of items) indicating items applicable to all the parts/members may be included.

The axis-associated item forming module 920 may cause the inter-axis matching module 925 to determine consistencies of the items formed by the axis-associated item forming module 920 between different axes.

There may be certain items which are difficult to classify into an exact item in each axis, for example, items applicable to all the parts/members, system parameters, and external disturbance. The axis-associated item forming module 920 may form such items such that they are deployed in parallel with the items of the associated axes.

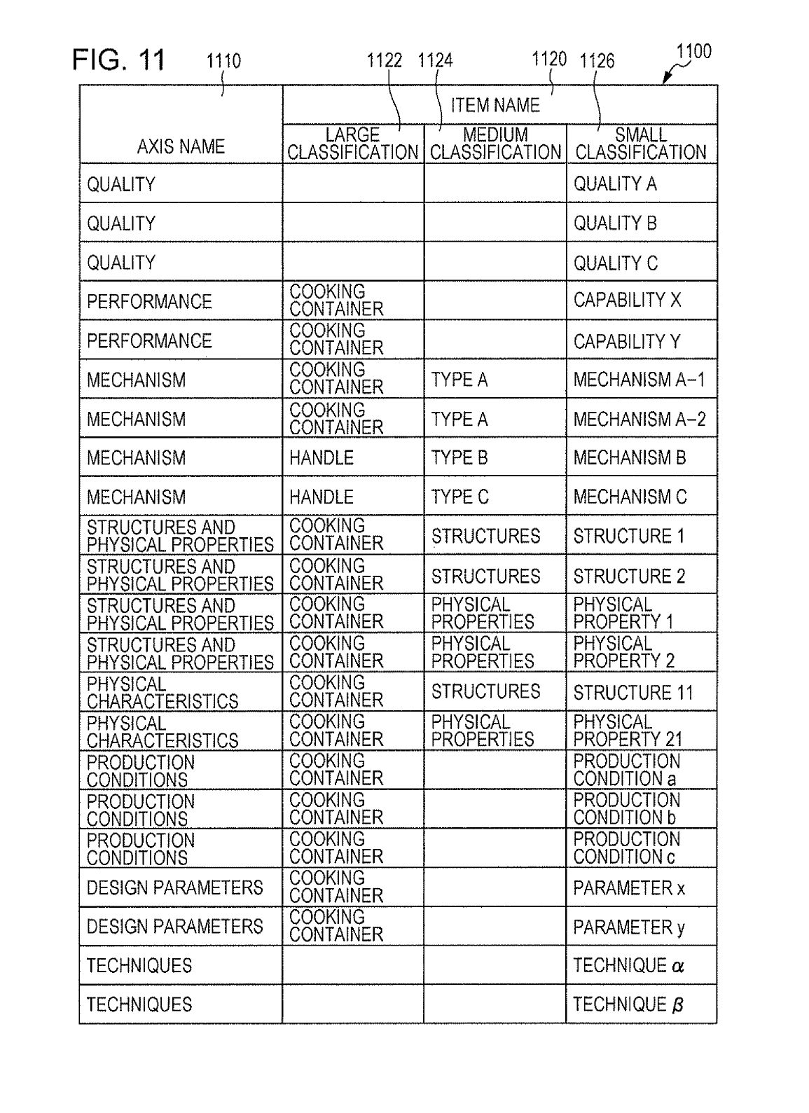

Items associated with the axes may have a hierarchical structure having at least one level, such as an axis item table 1100 shown in FIG. 11. FIG. 11 shows an example of the data structure of the axis item table 1100. The axis item table 1100 includes an axis name column 1110 and an item name column 1120. In the axis name column 1110 stores therein names of axes. The item name column 1120 stores therein item names associated with the axes. The items have a hierarchical structure having, for example, three levels, such as large, medium, and small classifications. The item name column 1120 includes a large classification column 1122, a medium classification column 1124, and a small classification column 1126. The large classification column 1122 stores therein, as the first level, items classified under the large classification. The medium classification column 1124 stores therein, as the second level, items classified under the medium classification. The small classification column 1126 stores therein, as the third level, items classified under the small classification. The hierarchical structure may have only one level having a small classification, two levels having large and small classifications, and three levels having large, medium, and small classifications.

The inter-axis matching module 925 is connected to the axis-associated item forming module 920. The inter-axis matching module 925 determines whether there is a consistency of items of a predetermined hierarchical level at least between the first and second axes, the second and third axes, and the third and fourth axes. If the inter-axis matching module 925 determines that there is no consistency of items, it may correct a corresponding item. In this case, corrections may be made automatically or in accordance with an operation of an operator (for example, correction patterns are shown and an operator is instructed to select one of the correction patterns, or a warning is issued and an operator is instructed to correct an item).

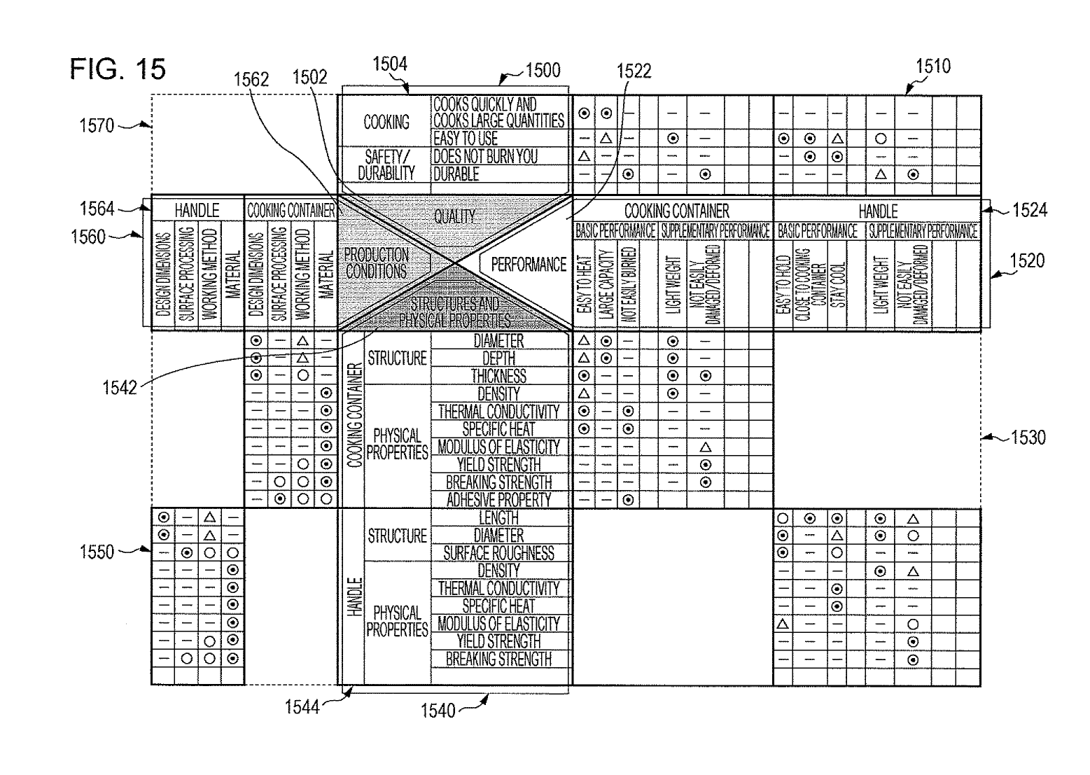

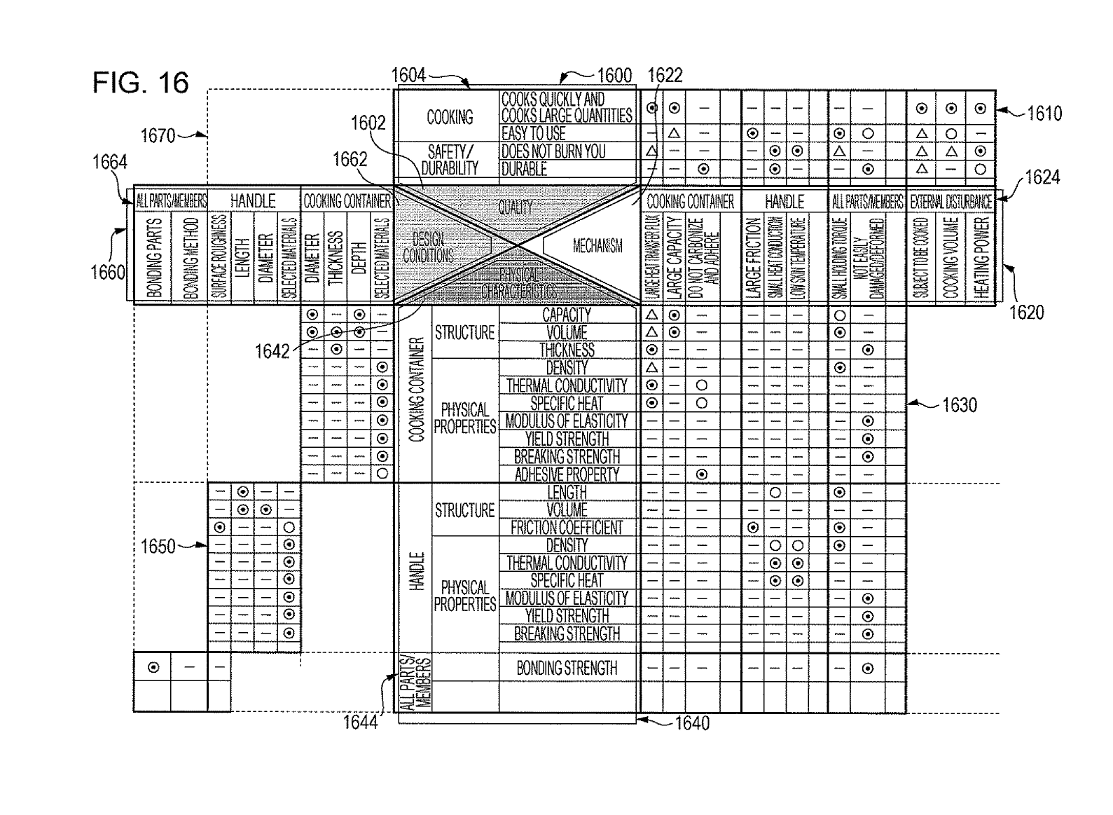

The display module 930 is connected to the axis-associated item forming module 920. On the basis of the names of the axes set by the axis-name setting module 910 and the items formed by the axis-associated item forming module 920, the display module 930 displays a QFD chart used for developing a product, in which the names of the first through fourth axes are deployed within a region divided into top, bottom, right and left sections from the center of the QFD chart, the items associated with the first through fourth axes are deployed in the directions extending upward, downward, rightward, and leftward from the center, and matrices into which cause-and-effect relationships between associated items may be input are deployed at least between the first and second axes, the second and third axes, and the third and fourth axes. The QFD chart displayed by the display module 930 may be a parts/members QFD chart, such as that shown in FIG. 15, or a system QFD chart, such as that shown in FIG. 16, which will be discussed later.

The axis-related information storage module 950 is connected to the axis-name setting module 910 and the axis-associated item forming module 920. The axis-related information storage module 950 stores therein information related to axes, for example, the axis item table 1100 shown in FIG. 11.

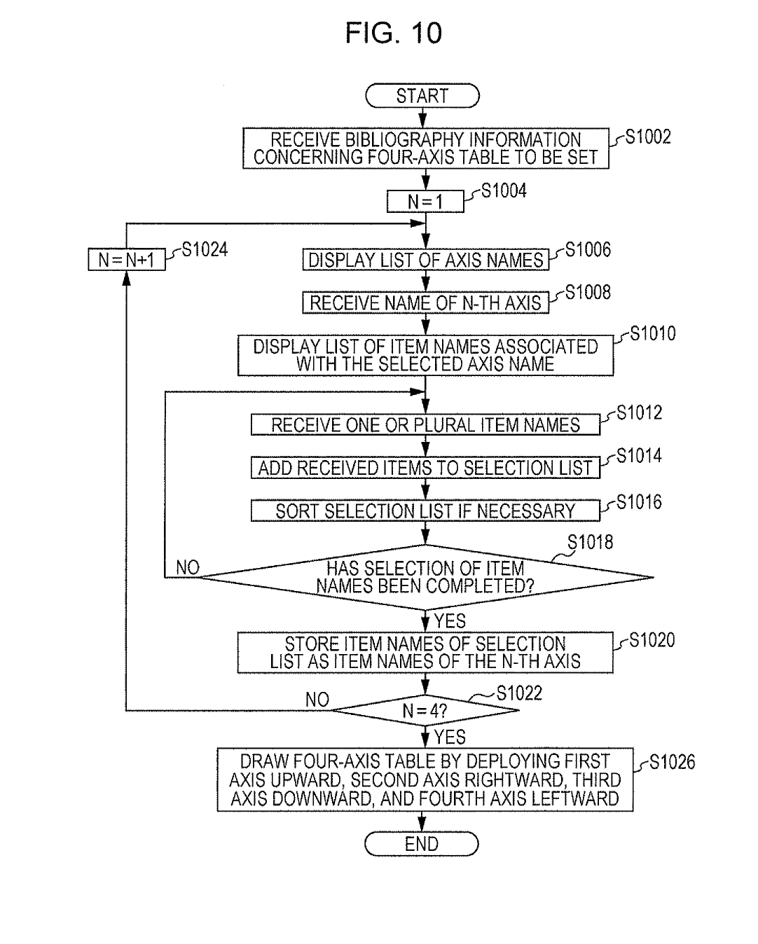

FIG. 10 is a flowchart illustrating an example of processing according to the second exemplary embodiment.

In step S1002, the axis-name setting module 910 receives bibliography information concerning a four-axis table to be set. Examples of the bibliography information are an operator name, an operator identifier, the date and time at which a table is created, and a product name.

In step S1004, the axis-name setting module 910 sets a variable N to be 1 (N=1). The variable N is a value indicating an axis number.

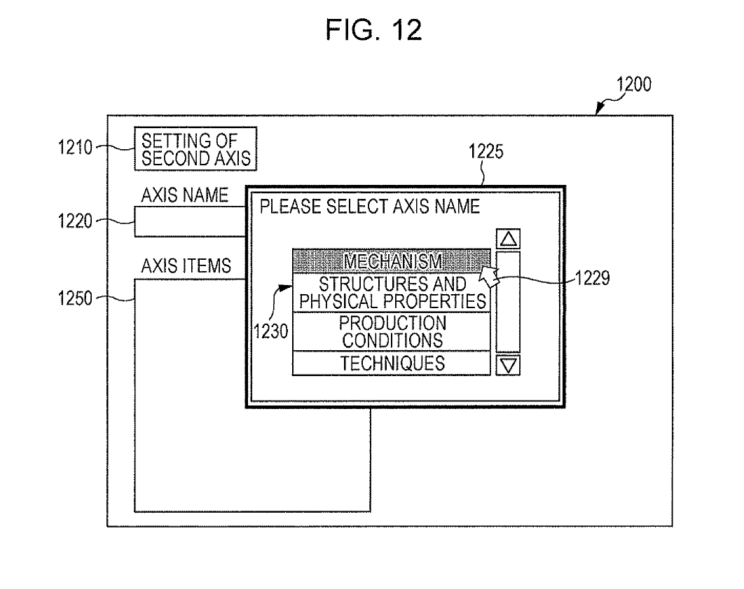

In step S1006, the axis-name setting module 910 displays a list of axis names. FIG. 12 shows an example of processing for displaying and selecting axis names. On a setting screen 1200, such as a liquid crystal display, provided in the information processing apparatus 900, an N-th axis setting column 1210, an axis-name setting column 1220, and an axis-item setting column 1250 are displayed. The N-th axis setting column 1210 displays a currently selected axis, i.e., an N-th axis, in accordance with the value of the variable N set in step S1004 or S1024. When an operator selects the axis-name setting column 1220 by performing a selecting operation, an axis-name selecting area 1225 including an axis-name list display area 1230 is displayed. Then, the operator is instructed to select one of the axis names displayed in the axis-name list display area 1230 by using a cursor 1229. The axis names within the axis-name list display area 1230 may be extracted from the axis name column 1110 of the axis item table 1100.

In step S1008, the axis-name setting module 910 receives a name of the N-th axis.

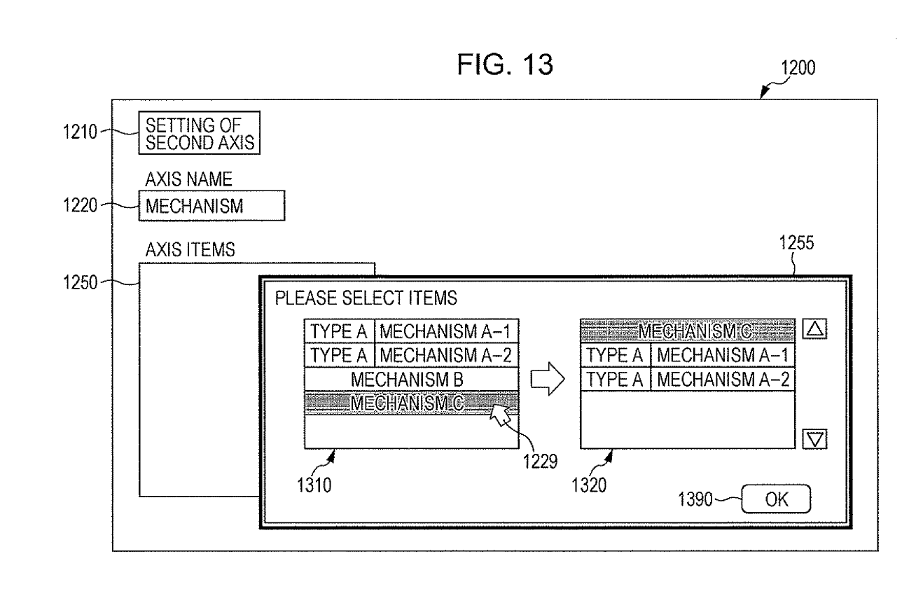

In step S1010, the axis-associated item forming module 920 displays a list of item names associated with the selected axis name. FIG. 13 shows an example of processing for displaying and selecting axis items. On the setting screen 1200, the N-th axis setting column 1210, the axis-name setting column 1220, and the axis-item setting column 1250 are displayed. When the operator selects the axis-item setting column 1250 by performing a selecting operation, an item selecting area 1255 including an item selecting table 1310 and a selection-result display table 1320 is displayed. When the operator selects an item within the item selecting table 1310 by using the cursor 1229, the selected item is moved to the selection-result display table 1320 and is displayed. The item names within the item selecting table 1310 may be extracted from the item name column 1120 of the axis item table 1100.

In step S1012, the axis-associated item forming module 920 receives one or plural item names.

In step S1014, the axis-associated item forming module 920 adds the received items to a selection list.

In step S1016, if necessary, the axis-associated item forming module 920 sorts the selection list. For example, items in the selection list may be sorted in accordance with the order of items of an axis for which items have already been selected.

In step S1018, the axis-associated item forming module 920 determines whether the selection of item names has been completed. If the result of step S1018 is YES, the process proceeds to step S1020. If the result of step S1018 is NO, the process returns to step S1012. For example, if an OK button 1390 displayed within the item selecting area 1255 shown in FIG. 13 is operated by the operator, the axis-associated item forming module 920 determines that the selection of item names has been completed.

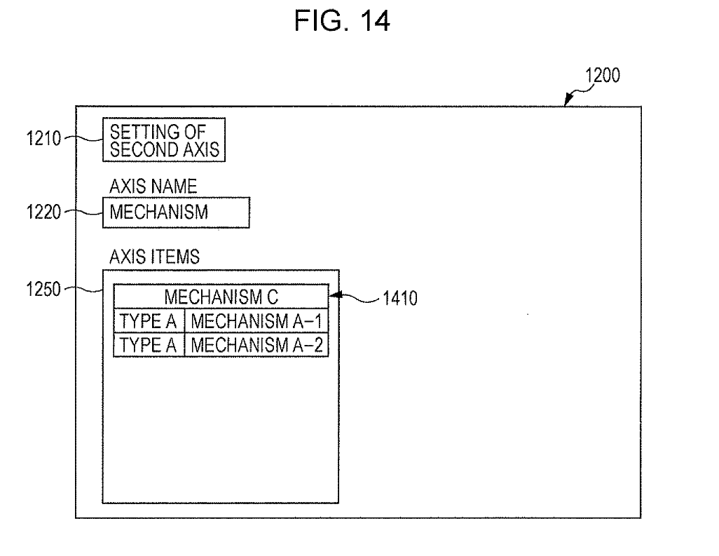

In step S1020, the axis-associated item forming module 920 stores the item names of the selection list in the axis-related information storage module 950 as the item names of the N-th axis. FIG. 14 shows a display example of the selected axis name and the selected items. A currently selected axis is displayed in the N-th axis setting column 1210, the name of the axis is displayed in the axis-name setting column 1220, and an axis/item setting result table 1410 is displayed in the axis-item setting column 1250. A combination of the N-th axis setting column 1210, the axis-name setting column 1220, and the axis/item setting result table 1410 is stored in the axis-related information storage module 950.

In step S1022, the axis-associated item forming module 920 determines whether N is four. If the result of step S1022 is YES, the process proceeds to step S1026. If the result of step S1022 is NO, the process proceeds to step S1024.

In step S1024, the axis-name setting module 910 increments N by one (N=N+1).

In this example of processing, the first through fourth axes are sequentially received. However, the operator may select, as desired, axis numbers to which axis names and items associated with the axes are to be appended.

In step S1026, the display module 930 draws a four-axis table by deploying the first axis upward, the second axis rightward, the third axis downward, and the fourth axis leftward.

For example, the four-axis table may be displayed as the parts/members QFD chart shown in FIG. 15 or the system QFD chart shown in FIG. 16.

In the example shown in FIG. 15, four axes (a quality axis (first axis) 1500, a performance axis (second axis) 1520, a structures/physical-properties axis (third axis) 1540, and a production-conditions axis (fourth axis) 1560) are shown. The names of the individual axes are displayed in end triangular portions of the four axes 1500, 1520, 1540, and 1560, which are an axis-name display area (quality) 1502, an axis-name display area (performance) 1522, an axis-name display area (structures and physical properties) 1542, and an axis-name display area (production conditions) 1562. Items associated with the quality axis (first axis) 1500 are displayed in an item-name display area 1504 extending upward from the axis-name display area 1502. Items associated with the performance axis (second axis) 1520 are displayed in an item-name display area 1524 extending rightward from the axis-name display area 1522. Items associated with the structures/physical-properties axis (third axis) 1540 are displayed in an item-name display area 1544 extending downward from the axis-name display area 1542. Items associated with the production-conditions axis (fourth axis) 1560 are displayed in an item-name display area 1564 extending leftward from the axis-name display area 1562. Then, at least in three areas, that is, in an item-correlation area 1510 between the item-name display areas 1504 and 1524, in an item-correlation area 1530 between the item-name display areas 1524 and 1544, and in an item-correlation area 1550 between the item-name display areas 1544 and 1564, matrices are generated. In these matrices, for example, in a matrix generated in the item-correlation area 1510, at a position at which two associated items displayed in the item-name display areas 1504 and 1524 intersect with each other, a cause-and-effect relationship between these two items may be input. For example, at a position between an item “does not burn you” of “safety/durability” in the item-name display area 1504 and an item “stay cool” of “basic performance” of “handle” in the item-name display area 1524, a symbol ⊙ indicating a strong correlation is input. The correlation between two associated items may be represented by a numeric value, a color, or a combination thereof. For example, if a positive correlation is indicated by a red symbol and a negative correlation is indicated by a blue symbol, signs (+ and −) of a correlation may also be indicated, in addition to the strength of a correlation. In an item-correlation area 1570 between the item-name display areas 1504 and 1564, a matrix into which cause-and-effect relationships between items in the item-correlation areas 1504 and 1564 may be input may be generated. In this parts/members QFD chart, influences of “production conditions” on “quality” can be examined from the relationships between “production conditions” and “structures and physical properties”, the relationships between “structures and physical properties” and “performance”, and between “performance” and “quality”. That is, the information processing apparatus 900 of the second exemplary embodiment makes it easier to clarify a mechanism for obtaining a certain result, i.e., “quality” (phenomenon), from “production conditions” through “structures and physical properties” and “performance”, than the use of information processing apparatuses other than the second exemplary embodiment. For example, it is possible to understand in advance the fact that certain measures to improve the quality of one factor may decrease the quality of another factor and the reason for this fact. Then, if a development technical problem occurs, it is possible to extract an analytic technique for examining reasons or measures for this problem, and also to obtain such an analytic technique in advance.

For example, in order to fill in the matrix concerning the second axis, it is necessary to understand the mechanism of functions of individual parts and members. By checking for portions of the matrix into which an operator is unable to input a symbol, a numeric value, etc., indicating a relationship between items, necessary analytic techniques can be extracted.

Generally, the factors indicated in the individual axes are handled by different departments, and thus, collaboration between different departments can be promoted.

The example shown in FIG. 16 is similar to that shown in FIG. 15. However, since the example shown in FIG. 16 concerns a system QFD chart, it has an item “all parts/members” in addition to items concerning individual parts and members, as stated above. By using this system QFD chart, influences of “design conditions” on “quality” can be examined from the relationships between “design conditions” and “physical characteristics”, the relationships between “physical characteristics” and “mechanism”, and the relationships between “mechanism” and “quality”. That is, the information processing apparatus 900 of the second exemplary embodiment makes it easier to clarify a mechanism for obtaining a certain result, i.e., “quality” (phenomenon), from “design conditions” through “physical characteristics” and “mechanism”, than the use of information processing apparatuses other than the second exemplary embodiment. For example, it is possible to understand in advance the fact that certain measures to improve the quality of one factor may decrease the quality of another factor and the reason for this fact. Then, if a development technical problem occurs, it is possible to extract an analytic technique for examining reasons or measures for this problem, and also to obtain such an analytic technique in advance.

For example, in order to fill in the matrix concerning the second axis, it is necessary to understand a physical mechanism in which characteristics determined by design conditions influence the quality. By checking for portions of the matrix into which an operator is unable to input a symbol, a numeric value, etc., indicating a relationship between items, necessary analytic techniques can be extracted.

After an operator has input symbols, numeric values, etc. indicating correlations between items, if there are some portions of matrices into which symbols, numeric values, etc. are not input, the display module 930 may display information that there are some items for which correlations are not indicated. For example, such portions of the matrices may be displayed in a color different from the color of the other portions of the matrices in which correlations are indicated.

Additionally, items of a matrix concerning the third axis into which correlations are not indicated may be extracted, and the display module 930 may indicate that such items are included as items of “structures/physical-properties” in association with “performance” but correlations are not indicated because of an insufficient measurement technique.

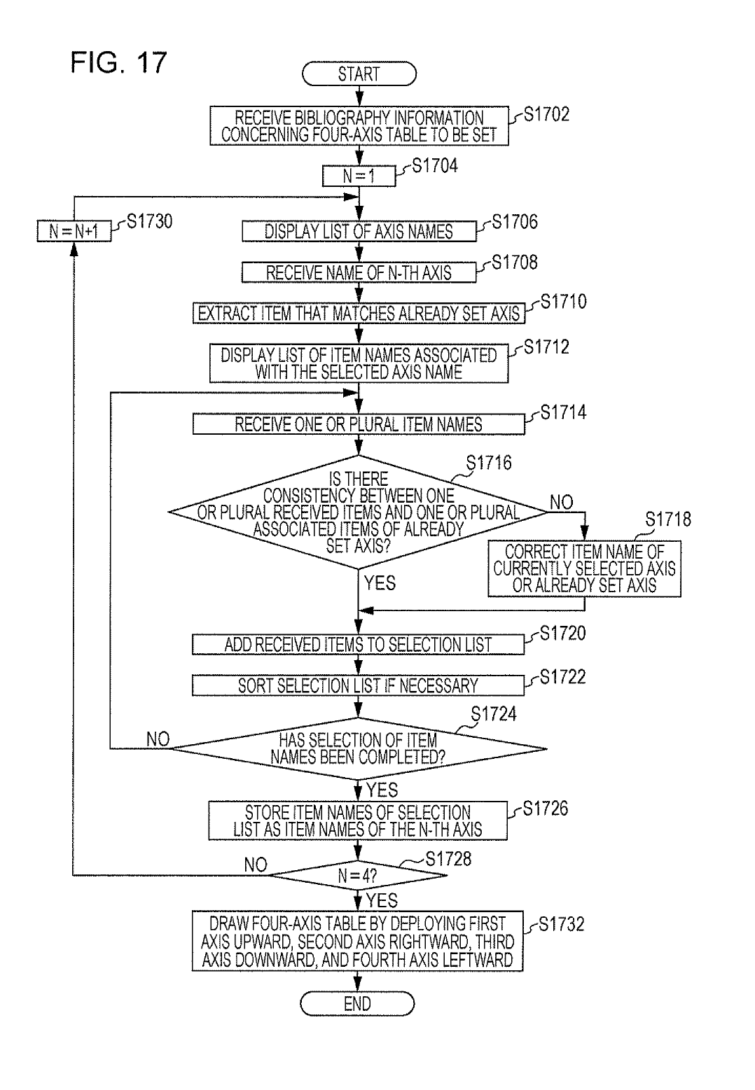

FIG. 17 is a flowchart illustrating another example of processing according to the second exemplary embodiment. In this flowchart, steps S1710, S1716, and S1718 are added to the steps of the flowchart in FIG. 10. Details of steps S1710, S1716, and S1718 will be given. The other steps are similar to those in FIG. 10.

In step S1702, the axis-name setting module 910 receives bibliography information concerning a four-axis table to be set.

In step S1704, the axis-name setting module 910 sets a variable N to be 1 (N=1).

In step S1706, the axis-name setting module 910 displays a list of axis names.

In step S1708, the axis-name setting module 910 receives a name of the N-th axis.

In step S1710, an item that matches a certain item of an axis for which items have already been set is extracted. The axis-associated item forming module 920 causes the inter-axis matching module 925 to perform this processing. For example, an item that matches the item classified under the large classification of the hierarchical structure of an already set axis is extracted. As the axis for which items have already been set (hereinafter simply referred to as an “already set axis”), an axis which forms a matrix together with a currently selected axis may be used. For example, if the currently selected axis is the second axis, the already set axis is the first axis. If the currently selected axis is the third axis, the already set axis is the second axis. If the currently selected axis is the fourth axis, the already set axis is the third axis.

In step S1712, the axis-associated item forming module 920 displays a list of item names associated with the selected axis name. In this case, only the items extracted in step S1710 may be displayed. Alternatively, items other than the items extracted in step S1710 may also be included, in which case, the items extracted in step S1710 may be displayed in a mode (shape, pattern, color, or a combination thereof) different from that of the other items.

In step S1714, the axis-associated item forming module 920 receives one or plural item names.

In step S1716, the inter-axis matching module 925 determines whether there is a consistency between one or plural items selected in step S1714 and one or plural associated items of the already set axis. If the result of step S1716 is YES, the process proceeds to step S1720. If the result of step S1716 is NO, the process proceeds to step S1718. In this case, “having a consistency” means that items are formed in a hierarchical structure and the name of an item associated with the currently selected axis classified under a predetermined level of the hierarchical structure is the same as that associated with the already set axis. The already set axis may be an axis which forms a matrix with a currently selected axis, as stated above. If there is an item that does not match a certain item of the already set axis, the process proceeds to step S1718.

In step S1718, the axis-associated item forming module 920 corrects the name of the item of the currently selected axis or the already set axis. In this case, the operator is allowed to correct the name of the item of the currently selected axis or the already set axis. However, the operator does not necessarily have to make correction.

In step S1720, the axis-associated item forming module 920 adds the received items to a selection list.

In step S1722, if necessary, the axis-associated item forming module 920 sorts the selection list.

In step S1724, the axis-associated item forming module 920 determines whether the selection of item names has been completed. If the result of step S1724 is YES, the process proceeds to step S1726. If the result of step S1724 is NO, the process returns to step S1714.

In step S1726, the axis-associated item forming module 920 stores the item names of the selection list in the axis-related information storage module 950 as the item names of the N-th axis.

In step S1728, the axis-associated item forming module 920 determines whether N is four. If the result of step S1728 is YES, the process proceeds to step S1732. If the result of step S1728 is NO, the process proceeds to step S1730.

In step S1730, the axis-name setting module 910 increments N by one (N=N+1).

In step S1732, the display module 930 draws a four-axis table by deploying the first axis upward, the second axis rightward, the third axis downward, and the fourth axis leftward.

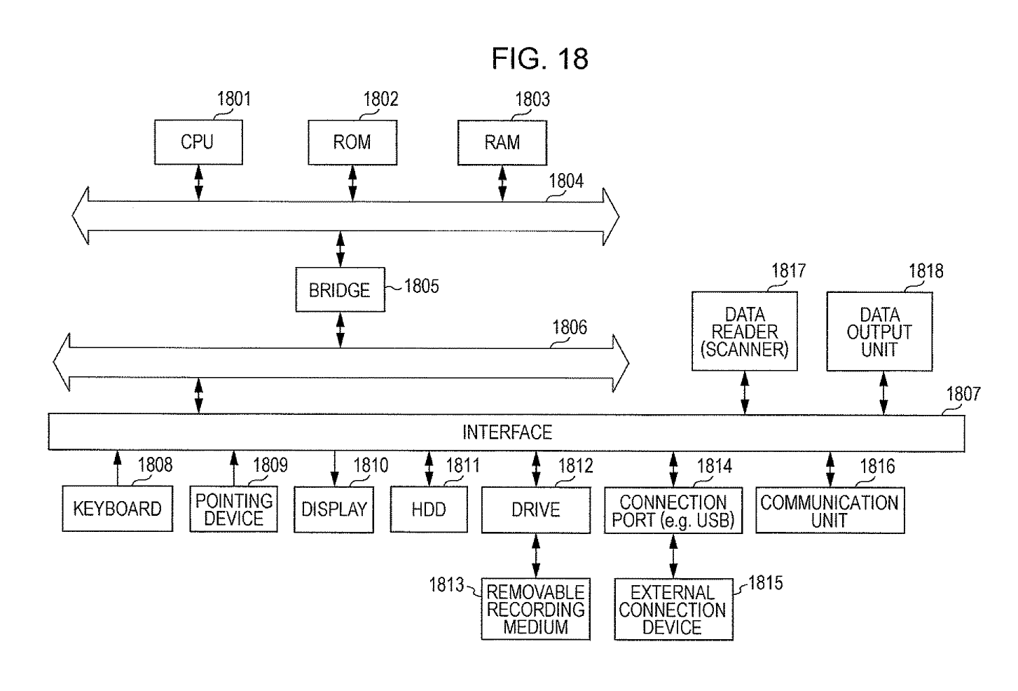

An example of the hardware configuration of the information processing apparatuses 100 and 900 of the first and second exemplary embodiments will be described below with reference to FIG. 18. The configuration shown in FIG. 18 is an example of the hardware configuration of, for example, a personal computer (PC), including a data reader 1817, such as a scanner, and a data output unit 1818, such as a printer.

A central processing unit (CPU) 1801 is a controller that executes processing in accordance with a computer program which describes an execution sequence of modules discussed in the above-described first and second exemplary embodiments, such as the chart-A receiving module 110A, the chart-B receiving module 110B, the chart integrating module 120, the relationship checking module 130, the relationship-inconsistency handling module 140, the display module 150, the axis-name setting module 910, the parts/system selecting module 915, the axis-associated item forming module 920, the inter-axis matching module 925, and the display module 930.

A read only memory (ROM) 1802 stores therein programs and operation parameters used by the CPU 1801. A random access memory (RAM) 1803 stores therein a program used during the execution of the CPU 1801 and parameters which vary appropriately during the execution of the CPU 1801. The CPU 1801, the ROM 1802, and the RAM 1803 are connected to one another via a host bus 1804, such as a CPU bus.

The host bus 1804 is connected to an external bus 1806, such as a Peripheral Component Interconnect/Interface (PCI) bus, via a bridge 1805.

A keyboard 1808 and a pointing device 1809, such as a mouse, are input devices operated by an operator. A display 1810, such as a liquid crystal display device or a cathode ray tube (CRT), displays various items of information as text or image information.

A hard disk drive (HDD) 1811 contains a hard disk and drives the hard disk to record or play back information or a program executed by the CPU 1801. In the hard disk, the axis item table 1100, set axis names, set item names, etc. are stored. Various other computer programs, such as various data processing programs, are also stored in the hard disk.

A drive 1812 reads data or a program recorded on a removable recording medium 1813 set in the drive 1812, such as a magnetic disk, an optical disc, a magneto-optical disk, or a semiconductor memory, and supplies the read data or program to the RAM 1803 connected to the drive 1812 via an interface 1807, the external bus 1806, the bridge 1805, and the host bus 1804. As the hard disk, the removable recording medium 1813 is also usable as a data recording region, which is similar to a hard disk.

A connection port 1814 is a port used for connecting an external connection device 1815 to the PC, and has a connecting portion, such as a Universal Serial Bus (USB) port or an IEEE1394 port. The connection port 1814 is connected to, for example, the CPU 1801, via the interface 1807, the external bus 1806, the bridge 1805, and the host bus 1804. A communication unit 1816 is connected to a communication line and executes data communication processing with external sources. The data reader 1817 is, for example, a scanner, and executes processing for reading documents. The data output unit 1818 is, for example, a printer, and executes processing for outputting document data.

The hardware configuration of the information processing apparatus 100 or 900 shown in FIG. 18 is only an example, and the exemplary embodiments may be configured in any manner as long as the modules described in the exemplary embodiments are executable. For example, some modules may be configured as dedicated hardware (e.g., an application specific integrated circuit (ASIC)), or some modules may be installed in an external system and be connected to the PC via a communication line. Alternatively, a system, such as that shown in FIG. 18, may be connected to a system, such as that shown in FIG. 18, via a communication line, and may be operated in cooperation with each other.

In the above-described first and second exemplary embodiments, when comparing a certain value with a predetermined value, “equal to or greater than”, “equal to or smaller than”, “greater than”, and “smaller than” may also be read as “greater than”, “smaller than”, “equal to or greater than”, and “equal to or smaller than”, respectively, unless there is an inconsistency between a combination of two values to be compared.

The above-described program may be stored in a recording medium and be provided. The program recorded on a recording medium may be provided via a communication medium. In this case, the above-described program may be implemented as a “non-transitory computer readable medium storing the program therein” in an exemplary embodiment of the invention.

The “non-transitory computer readable medium storing a program therein” is a recording medium storing a program therein that can be read by a computer, and is used for installing, executing, and distributing the program.

Examples of the recording medium are digital versatile disks (DVDs), and more specifically, DVDs standardized by the DVD Forum, such as DVD-R, DVD-RW, and DVD-RAM, DVDs standardized by the DVD+RW Alliance, such as DVD+R and DVD+RW, compact discs (CDs), and more specifically, a read only memory (CD-ROM), a CD recordable (CD-R), and a CD rewritable (CD-RW), Blu-ray disc (registered), a magneto-optical disk (MO), a flexible disk (FD), magnetic tape, a hard disk, a ROM, an electrically erasable programmable read only memory (EEPROM) (registered), a flash memory, a RAM, a secure digital (SD) memory card, etc.

The entirety or part of the above-described program may be recorded on such a recording medium and stored therein or distributed. Alternatively, the entirety or part of the program may be transmitted through communication by using a transmission medium, such as a wired network used for a local area network (LAN), a metropolitan area network (MAN), a wide area network (WAN), the Internet, an intranet, or an extranet, a wireless communication network, or a combination of such networks. The program may be transmitted by using carrier waves.

The above-described program may be part of another program, or may be recorded, together with another program, on a recording medium. The program may be divided and recorded on plural recording media. Further, the program may be recorded in any form, e.g., it may be compressed or encrypted, as long as it can be reconstructed.

The second exemplary embodiment discussed with reference to FIGS. 9 through 17 may be implemented as follows. The first exemplary embodiment may be combined with the second exemplary embodiment.

(A1) An information processing apparatus comprising:

an axis-name setting unit that sets names of first through fourth axes;

an item forming unit that forms an item associated with an axis for which a name is set by the axis-name setting unit; and

a display that displays, on the basis of the names of the first through fourth axes set by the axis-name setting unit and the items formed by the item forming unit, a quality function deployment chart used for developing a product, in which the names of the first through fourth axes are deployed in a region divided into top, bottom, right, and left sections from a center of the quality function deployment chart, the items associated with the first through fourth axes are deployed in directions extending upward, downward, rightward, and leftward from the center, and matrices into which relationships between items are input are deployed at least between the first axis and the second axis, between the second axis and the third axis, and between the third axis and the fourth axis,

wherein the item forming unit forms items associated with the first through fourth axes as a result of an operator selecting an item indicating a quality requirement of the product as an item associated with the first axis, an item indicating a performance capability necessary for satisfying a quality requirement of the product by each of parts and members of the product as an item associated with the second axis, an item concerning a structure and a physical property of each of the parts and the members of the product as an item associated with the third axis, and an item which defines a production condition for each of the parts and the members of the product as an item associated with the fourth axis.

(A2) An information processing apparatus comprising:

an axis-name setting unit that sets names of first through fourth axes;

an item forming unit that forms an item associated with an axis for which a name is set by the axis-name setting unit; and

a display that displays, on the basis of the names of the first through fourth axes set by the axis-name setting unit and the items formed by the item forming unit, a quality function deployment chart used for developing a product, in which the names of the first through fourth axes are deployed in a region divided into top, bottom, right, and left sections from a center of the quality function deployment chart, the items associated with the first through fourth axes are deployed in directions extending upward, downward, rightward, and leftward from the center, and matrices into which relationships between items are input are deployed at least between the first axis and the second axis, between the second axis and the third axis, and between the third axis and the fourth axis,

wherein the item forming unit forms items associated with the first through fourth axes as a result of an operator selecting an item indicating a quality requirement of the product as an item associated with the first axis, an item concerning a physical mechanism which dominates a quality of the product, the behavior of the physical mechanism being determined by an item of a physical characteristic, as an item associated with the second axis, an item indicating a system physical characteristic determined by a design condition as an item associated with the third axis, and an item indicating a design condition as an item associated with the fourth axis.

(A3) The information processing apparatus according to (A1) or (A2), wherein the axis-name setting unit displays an axis name list for the operator, and sets names selected from the axis name list by the operator as the names of the axes.

(A4) The information processing apparatus according to one of (A1) to (A3), wherein the item forming unit displays an item list for the operator, and sets items selected from the item list by the operator as the items associated with the axes.

(A5) The information processing apparatus according to one of (A1) to (A4), wherein:

the items associated with the axes have a hierarchical structure; and

the item forming unit determines whether there is a consistency of items in a predetermined level of the hierarchical structure at least between the first axis and the second axis, between the second axis and the third axis, and between the third axis and the fourth axis, and if it is determined that there is no consistency of items in the predetermined level of the hierarchical structure, the item forming unit corrects an item of one axis which is not consistent with an associated item of an associated axis to be compared.

(A6) A non-transitory computer readable medium storing a program causing a computer to execute a process, the process comprising:

setting names of first through fourth axes;

forming an item associated with an axis for which a name is set; and

displaying, on the basis of the set names of the first through fourth axes and the formed items, a quality function deployment chart used for developing a product, in which the names of the first through fourth axes are deployed in a region divided into top, bottom, right, and left sections from a center of the quality function deployment chart, the items associated with the first through fourth axes are deployed in directions extending upward, downward, rightward, and leftward from the center, and matrices into which relationships between items are input are deployed at least between the first axis and the second axis, between the second axis and the third axis, and between the third axis and the fourth axis,

wherein items associated with the first through fourth axes are formed as a result of an operator selecting an item indicating a quality requirement of the product as an item associated with the first axis, an item indicating a performance capability necessary for satisfying a quality requirement of the product by each of parts and members of the product as an item associated with the second axis, an item concerning a structure and a physical property of each of the parts and the members of the product as an item associated with the third axis, and an item which defines a production condition for each of the parts and the members of the product as an item associated with the fourth axis.

(A7) A non-transitory computer readable medium storing a program causing a computer to execute a process, the process comprising:

setting names of first through fourth axes;

forming an item associated with an axis for which a name is set; and

displaying, on the basis of the set names of the first through fourth axes and the formed items, a quality function deployment chart used for developing a product, in which the names of the first through fourth axes are deployed in a region divided into top, bottom, right, and left sections from a center of the quality function deployment chart, the items associated with the first through fourth axes are deployed in directions extending upward, downward, rightward, and leftward from the center, and matrices into which relationships between items are input are deployed at least between the first axis and the second axis, between the second axis and the third axis, and between the third axis and the fourth axis,

wherein items associated with the first through fourth axes are formed as a result of an operator selecting an item indicating a quality requirement of the product as an item associated with the first axis, an item concerning a physical mechanism which dominates a quality of the product, the behavior of the physical mechanism being determined by an item of a physical characteristic, as an item associated with the second axis, an item indicating a system physical characteristic determined by a design condition as an item associated with the third axis, and an item indicating a design condition as an item associated with the fourth axis.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a first receiver that receives a first quality function deployment chart having at least three axes, items which are formed in a hierarchical structure being appended to each of the axes, an axis name being appended to each of the axes, and an item name being appended to each of the items;
a second receiver that receives a second quality function deployment chart, which is different from the first quality function deployment chart; and
an integrating unit that integrates the first quality function deployment chart and the second quality function deployment chart into a third quality function deployment chart, wherein, concerning an axis of the first quality function deployment chart and an axis of the second quality function deployment chart having the same axis name, if part of an item name positioned in a highest hierarchical level of items associated with the axis of the first quality function deployment chart coincides with part of an item name positioned in a highest hierarchical level of items associated with the axis of the second quality function deployment chart and if a remaining part of the item name of the first quality function deployment chart does not coincide with a remaining part of the item name of the second quality function deployment chart, the integrating unit sets the consistent parts to be an item name in a highest hierarchical level of items on an associated axis of the third quality function deployment chart and sets the inconsistent parts to be item names in a second highest hierarchical level of items on the associated axis of the third quality function deployment chart.

2. An information processing apparatus comprising:
a first receiver that receives a first quality function deployment chart having at least three axes, items which are formed in a hierarchical structure being appended to each of the axes, an axis name being appended to each of the axes, and an item name being appended to each of the items;
a second receiver that receives a second quality function deployment chart, which is different from the first quality function deployment chart; and
an integrating unit that integrates the first quality function deployment chart and the second quality function deployment chart into a third quality function deployment chart, wherein, concerning an axis of the first quality function deployment chart and an axis of the second quality function deployment chart having the same axis name, as a result of sequentially extracting items associated with the axes of the first quality function deployment chart and the second quality function deployment chart starting from a highest hierarchical level of the items, if an item name positioned in a certain hierarchical level of the first quality function deployment chart coincides with an item name in the certain hierarchical level of the second quality function deployment chart and if an item name positioned in a hierarchical level lower than the certain hierarchical level of the first quality function deployment chart does not coincide with an item name positioned in a hierarchical level lower than the certain hierarchical level of the second quality function deployment chart, the integrating unit sets the consistent item names to be a common item name in the certain hierarchical level of items on an associated axis of the third quality function deployment chart and disposes the inconsistent item names in parallel in a corresponding hierarchical level of items on the associated axis of the third quality function deployment chart.

3. The information processing apparatus according to claim 1, wherein, concerning an axis of the first quality function deployment chart and an axis of the second quality function deployment chart having the same axis name, if item names of items associated with the axis of the first quality function deployment chart coincide with item names of items associated with the axis of the second quality function deployment chart and if the hierarchical structures of the items of the first quality function deployment chart and the second quality function deployment chart are the same, the integrating unit integrates the first quality function deployment chart and the second quality function deployment chart into the third quality function deployment chart by integrating two consistent item names of the first quality function deployment chart and the second quality function deployment chart into a single item name in the third quality function deployment chart.

4. The information processing apparatus according to claim 2, wherein, concerning an axis of the first quality function deployment chart and an axis of the second quality function deployment chart having the same axis name, if item names of items associated with the axis of the first quality function deployment chart coincide with item names of items associated with the axis of the second quality function deployment chart and if the hierarchical structures of the items of the first quality function deployment chart and the second quality function deployment chart are the same, the integrating unit integrates the first quality function deployment chart and the second quality function deployment chart into the third quality function deployment chart by integrating two consistent item names of the first quality function deployment chart and the second quality function deployment chart into a single item name in the third quality function deployment chart.

5. The information processing apparatus according to claim 1, wherein, concerning an axis of the first quality function deployment chart and an axis of the second quality function deployment chart having the same axis name, if an item name positioned in a highest hierarchical level of items associated with the axis of the first quality function deployment chart coincides with an item name positioned in a highest hierarchical level of items associated with the axis of the second quality function deployment chart and if an item name positioned in a hierarchical level other than the highest hierarchical level of the items associated with the axis of the first quality function deployment chart does not coincide with an item name positioned in a hierarchical level other than the highest hierarchical level of the items associated with the axis of the second quality function deployment chart, the integrating unit integrates the first quality function deployment chart and the second quality function deployment chart into the third quality function deployment chart by disposing two inconsistent item names of the first quality function deployment chart and the second quality function deployment chart in parallel in the third quality function deployment chart.

6. The information processing apparatus according to claim 2, wherein, concerning an axis of the first quality function deployment chart and an axis of the second quality function deployment chart having the same axis name, if an item name positioned in a highest hierarchical level of items associated with the axis of the first quality function deployment chart coincides with an item name positioned in a highest hierarchical level of items associated with the axis of the second quality function deployment chart and if an item name positioned in a hierarchical level other than the highest hierarchical level of the items associated with the axis of the first quality function deployment chart does not coincide with an item name positioned in a hierarchical level other than the highest hierarchical level of the items associated with the axis of the second quality function deployment chart, the integrating unit integrates the first quality function deployment chart and the second quality function deployment chart into the third quality function deployment chart by disposing two inconsistent item names of the first quality function deployment chart and the second quality function deployment chart in parallel in the third quality function deployment chart.

7. The information processing apparatus according to claim 1, wherein, concerning an axis of the first quality function deployment chart and an axis of the second quality function deployment chart having the same axis name, if it is determined that an item name positioned in a highest hierarchical level of items associated with the axis of the first quality function deployment chart does not coincide with an item name positioned in a highest hierarchical level of items associated with the axis of the second quality function deployment chart, the integrating unit displays information indicating that it is not possible to integrate the first quality function deployment chart and the second quality function deployment chart.

8. The information processing apparatus according to claim 2, wherein, concerning an axis of the first quality function deployment chart and an axis of the second quality function deployment chart having the same axis name, if it is determined that an item name positioned in a highest hierarchical level of items associated with the axis of the first quality function deployment chart does not coincide with an item name positioned in a highest hierarchical level of items associated with the axis of the second quality function deployment chart, the integrating unit displays information indicating that it is not possible to integrate the first quality function deployment chart and the second quality function deployment chart.

9. The information processing apparatus according to claim 1, wherein:
a matrix which indicates relationships between items is deployed between two adjacent axes of each of the first quality function deployment chart and the second quality function deployment chart; and
if an item on each of the two axes of the first quality function deployment chart and an item of the associated axis of the second quality function deployment chart have been integrated, and if values, which indicate relationships between items, input in elements forming the matrix of the first quality function deployment chart do not coincide with values, which indicate relationships between items, input in elements forming the matrix of the second quality function deployment chart, the integrating unit displays information indicating that integration processing will not be performed since it is not possible to integrate the first quality function deployment chart and the second quality function deployment chart, or sets the values input in the elements forming the matrix of the first quality function deployment chart or the second quality function deployment chart to be values in associated elements forming a matrix of the third quality function deployment chart.

10. The information processing apparatus according to claim 2, wherein:
a matrix which indicates relationships between items is deployed between two adjacent axes of each of the first quality function deployment chart and the second quality function deployment chart; and
if an item on each of the two axes of the first quality function deployment chart and an item of the associated axis of the second quality function deployment chart have been integrated, and if values, which indicate relationships between items, input in elements forming the matrix of the first quality function deployment chart do not coincide with values, which indicate relationships between items, input in elements forming the matrix of the second quality function deployment chart, the integrating unit displays information indicating that integration processing will not be performed since it is not possible to integrate the first quality function deployment chart and the second quality function deployment chart, or sets the values input in the elements forming the matrix of the first quality function deployment chart or the second quality function deployment chart to be values in associated elements forming a matrix of the third quality function deployment chart.

11. An information processing method comprising:
receiving a first quality function deployment chart having at least three axes, items which are formed in a hierarchical structure being appended to each of the axes, an axis name being appended to each of the axes, and an item name being appended to each of the items;
receiving a second quality function deployment chart, which is different from the first quality function deployment chart; and
integrating the first quality function deployment chart and the second quality function deployment chart into a third quality function deployment chart, wherein, concerning an axis of the first quality function deployment chart and an axis of the second quality function deployment chart having the same axis name, if part of an item name positioned in a highest hierarchical level of items associated with the axis of the first quality function deployment chart coincides with part of an item name positioned in a highest hierarchical level of items associated with the axis of the second quality function deployment chart and if a remaining part of the item name of the first quality function deployment chart does not coincide with a remaining part of the item name of the second quality function deployment chart, the consistent parts are set to be an item name in a highest hierarchical level of items on an associated axis of the third quality function deployment chart and the inconsistent parts are set to be item names in a second highest hierarchical level of items on the associated axis of the third quality function deployment chart.

12. An information processing method comprising:
receiving a first quality function deployment chart having at least three axes, items which are formed in a hierarchical structure being appended to each of the axes, an axis name being appended to each of the axes, and an item name being appended to each of the items;
receiving a second quality function deployment chart, which is different from the first quality function deployment chart; and
integrating the first quality function deployment chart and the second quality function deployment chart into a third quality function deployment chart, wherein, concerning an axis of the first quality function deployment chart and an axis of the second quality function deployment chart having the same axis name, as a result of sequentially extracting items associated with the axes of the first quality function deployment chart and the second quality function deployment chart starting from a highest hierarchical level of the items, if an item name positioned in a certain hierarchical level of the first quality function deployment chart coincides with an item name in the certain hierarchical level of the second quality function deployment chart and if an item name positioned in a hierarchical level lower than the certain hierarchical level of the first quality function deployment chart does not coincide with an item name positioned in a hierarchical level lower than the certain hierarchical level of the second quality function deployment chart, the consistent item names are set to be a common item name in the certain hierarchical level of items on an associated axis of the third quality function deployment chart and the inconsistent item names are disposed in parallel in a corresponding hierarchical level of items on the associated axis of the third quality function deployment chart.

13. A non-transitory computer readable medium storing a program causing a computer to execute a process, the process comprising:
receiving a first quality function deployment chart having at least three axes, items which are formed in a hierarchical structure being appended to each of the axes, an axis name being appended to each of the axes, and an item name being appended to each of the items;
receiving a second quality function deployment chart, which is different from the first quality function deployment chart; and
integrating the first quality function deployment chart and the second quality function deployment chart into a third quality function deployment chart, wherein, concerning an axis of the first quality function deployment chart and an axis of the second quality function deployment chart having the same axis name, if part of an item name positioned in a highest hierarchical level of items associated with the axis of the first quality function deployment chart coincides with part of an item name positioned in a highest hierarchical level of items associated with the axis of the second quality function deployment chart and if a remaining part of the item name of the first quality function deployment chart does not coincide with a remaining part of the item name of the second quality function deployment chart, the consistent parts are set to be an item name in a highest hierarchical level of items on an associated axis of the third quality function deployment chart and the inconsistent parts are set to be item names in a second highest hierarchical level of items on the associated axis of the third quality function deployment chart.

14. A non-transitory computer readable medium storing a program causing a computer to execute a process, the process comprising:
receiving a first quality function deployment chart having at least three axes, items which are formed in a hierarchical structure being appended to each of the axes, an axis name being appended to each of the axes, and an item name being appended to each of the items;
receiving a second quality function deployment chart, which is different from the first quality function deployment chart; and
integrating the first quality function deployment chart and the second quality function deployment chart into a third quality function deployment chart, wherein, concerning an axis of the first quality function deployment chart and an axis of the second quality function deployment chart having the same axis name, as a result of sequentially extracting items associated with the axes of the first quality function deployment chart and the second quality function deployment chart starting from a highest hierarchical level of the items, if an item name positioned in a certain hierarchical level of the first quality function deployment chart coincides with an item name in the certain hierarchical level of the second quality function deployment chart and if an item name positioned in a hierarchical level lower than the certain hierarchical level of the first quality function deployment chart does not coincide with an item name positioned in a hierarchical level lower than the certain hierarchical level of the second quality function deployment chart, the consistent item names are set to be a common item name in the certain hierarchical level of items on an associated axis of the third quality function deployment chart and the inconsistent item names are disposed in parallel in a corresponding hierarchical level of items on the associated axis of the third quality function deployment chart.
